(19) United States
(12) Patent Application Publication
(10) Pub. No.: US 2026/0113222 A1
(43) Pub. Date: Apr. 23, 2026

(54) TECHNIQUES FOR TRANSMITTER EQUALIZATION BASED ON SAMPLING TIME OFFSETS ASSOCIATED WITH A USER EQUIPMENT

(71) Applicant: QUALCOMM Incorporated, San Diego, CA (US)

(72) Inventors: Aviv REGEV, Tel aviv (IL); Ronen SHAKED, Kfar Saba (IL); Michael LEVITSKY, Rehovot (IL); Tom BARAK, Rehovot (IL)

(21) Appl. No.: 18/923,520

(22) Filed: Oct. 22, 2024

(51) Int. Cl. H04L 25/03; H04L 25/02

(52) U.S. Cl. CPC H04L 25/03955; H04L 25/0204

(57) ABSTRACT

Methods, systems, and devices for wireless communications are described. In some cases, a network entity may estimate an uplink sampling time offset (STO) associated with a user equipment (UE) based on an uplink signal from the UE and may remove the uplink STO from a first estimated channel to generate a second estimated channel. Thus, the network entity may equalize a first downlink signal in accordance with the second estimated channel and may transmit the first downlink signal to the UE. The network entity may additionally receive an indication of a downlink STO associated with the UE based on transmission of the first downlink signal and may equalize a second downlink signal in accordance with a third estimated channel, where the third estimated channel is based on (e.g., free of) the uplink STO and the downlink STO.

### FIELD OF TECHNOLOGY

The following relates to wireless communications, including techniques for transmitter (Tx) equalization based on sampling time offsets (STOs) associated with a user equipment (UE).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include estimating an uplink sampling time offset (STO) associated with a user equipment (UE) based on uplink signal associated with the UE, where the uplink STO is removed from a first estimated channel to generate a second estimated channel, equalizing a first downlink signal in accordance with the second estimated channel based on removal of the uplink STO from the first estimated channel, transmitting the first downlink signal based on equalization of the first downlink signal, receiving an indication of a downlink STO associated with the UE based on transmission of the first downlink signal, equalizing a second downlink signal in accordance with a third estimated channel, where the third estimated channel is based on both the downlink STO associated with the UE and the uplink STO associated with the UE, and transmitting, to the UE, the second downlink signal based on equalization of the second downlink signal.

A network entity for wireless communications is described. The network entity may include one or more memories storing processor executable code, and one or more processors coupled with the one or more memories. The one or more processors may individually or collectively be operable to execute the code to cause the network entity to estimate an uplink STO associated with a UE based on uplink signal associated with the UE, where the uplink STO is removed from a first estimated channel to generate a second estimated channel, equalize a first downlink signal in accordance with the second estimated channel based on removal of the uplink STO from the first estimated channel, transmit the first downlink signal based on equalization of the first downlink signal, receive an indication of a downlink STO associated with the UE based on transmission of the first downlink signal, equalize a second downlink signal in accordance with a third estimated channel, where the third estimated channel is based on both the downlink STO associated with the UE and the uplink STO associated with the UE, and transmit, to the UE, the second downlink signal based on equalization of the second downlink signal.

Another network entity for wireless communications is described. The network entity may include means for estimating an uplink STO associated with a UE based on uplink signal associated with the UE, where the uplink STO is removed from a first estimated channel to generate a second estimated channel, means for equalizing a first downlink signal in accordance with the second estimated channel based on removal of the uplink STO from the first estimated channel, means for transmitting the first downlink signal based on equalization of the first downlink signal, means for receiving an indication of a downlink STO associated with the UE based on transmission of the first downlink signal, means for equalizing a second downlink signal in accordance with a third estimated channel, where the third estimated channel is based on both the downlink STO associated with the UE and the uplink STO associated with the UE, and means for transmitting, to the UE, the second downlink signal based on equalization of the second downlink signal.

A non-transitory computer-readable medium storing code for wireless communications is described. The code may include instructions executable by one or more processors to estimate an uplink STO associated with a UE based on uplink signal associated with the UE, where the uplink STO is removed from a first estimated channel to generate a second estimated channel, equalize a first downlink signal in accordance with the second estimated channel based on removal of the uplink STO from the first estimated channel, transmit the first downlink signal based on equalization of the first downlink signal, receive an indication of a downlink STO associated with the UE based on transmission of the first downlink signal, equalize a second downlink signal in accordance with a third estimated channel, where the third estimated channel is based on both the downlink STO associated with the UE and the uplink STO associated with the UE, and transmit, to the UE, the second downlink signal based on equalization of the second downlink signal.

In some examples of the method, network entities, and non-transitory computer-readable medium described herein, removal of the uplink STO from the first estimated channel may include operations, features, means, or instructions for generating a first phase correcting factor based on the uplink STO estimated by the network entity and extracting, from the first estimated channel, the second estimated channel based on the first phase correcting factor.

In some examples of the method, network entities, and non-transitory computer-readable medium described herein, equalizing the second downlink signal may include operations, features, means, or instructions for generating a second phase correcting factor associated with the downlink STO, applying the second phase correcting factor to the second estimated channel to generate the third estimated channel, where the third estimated channel may be an estimate of an actual downlink channel to be used for transmission of the second downlink signal, and equalizing the second downlink signal in accordance with the third estimated channel.

Some examples of the method, network entities, and non-transitory computer-readable medium described herein may further include operations, features, means, or instructions for transmitting a request for the UE to indicate information associated with the downlink STO of the UE, where reception of the indication may be based on the request.

In some examples of the method, network entities, and non-transitory computer-readable medium described herein, the request and the first downlink signal may be transmitted as part of a same downlink transmission.

In some examples of the method, network entities, and non-transitory computer-readable medium described herein, the request may be transmitted according to a periodic or aperiodic rate of transmission.

In some examples of the method, network entities, and non-transitory computer-readable medium described herein, the request may be transmitted via a physical layer at the UE.

Some examples of the method, network entities, and non-transitory computer-readable medium described herein may further include operations, features, means, or instructions for receiving a recommendation to update the downlink STO based on the second downlink signal.

In some examples of the method, network entities, and non-transitory computer-readable medium described herein, the recommendation may be based on whether the second downlink signal may be associated with an aggregated phase difference across samples received in a frequency domain.

In some examples of the method, network entities, and non-transitory computer-readable medium described herein, the recommendation may be received via an uplink control channel.

Some examples of the method, network entities, and non-transitory computer-readable medium described herein may further include operations, features, means, or instructions for transmitting a third downlink signal that may be equalized, by the network entity, in accordance with the second estimated channel, where the second estimated channel may be based on the first estimated channel and the uplink STO associated with the UE, receiving a second indication of an updated downlink STO associated with the UE based on transmission of the third downlink signal, equalizing a fourth downlink signal in accordance with a fourth estimated channel, where the fourth estimated channel may be based on both the updated downlink STO associated with the UE and the uplink STO associated with the UE, and transmitting the fourth downlink signal based on equalization of the fourth downlink signal.

In some examples of the method, network entities, and non-transitory computer-readable medium described herein, transmission of the third downlink signal may be based on reception of a recommendation to update the downlink STO or transmission of a request for the UE to update the downlink STO.

In some examples of the method, network entities, and non-transitory computer-readable medium described herein, the third downlink signal may be a repetition of the first downlink signal.

Some examples of the method, network entities, and non-transitory computer-readable medium described herein may further include operations, features, means, or instructions for estimating the uplink STO associated with the UE based on the uplink signal received from the UE.

In some examples of the method, network entities, and non-transitory computer-readable medium described herein, the first downlink signal may be further based on the downlink STO associated with the UE.

In some examples of the method, network entities, and non-transitory computer-readable medium described herein, the indication of the downlink STO may be received via an uplink control channel.

A method for wireless communications by a UE is described. The method may include receiving, from a network entity, a first downlink signal that is equalized in accordance with a second estimated channel, where the second estimated channel is based on a first estimated channel and an uplink STO associated with the UE, transmitting an indication of a downlink STO associated with the UE, where the downlink STO is based on the first downlink signal, and receiving, based on transmitting the indication of the downlink STO, a second downlink signal that is equalized in accordance with a third estimated channel, where the third estimated channel is based on both the downlink STO associated with the UE and the uplink STO associated with the UE.

A UE for wireless communications is described. The UE may include one or more memories storing processor executable code, and one or more processors coupled with the one or more memories. The one or more processors may individually or collectively be operable to execute the code to cause the UE to receive, from a network entity, a first downlink signal that is equalized in accordance with a second estimated channel, where the second estimated channel is based on a first estimated channel and an uplink STO associated with the UE, transmit an indication of a downlink STO associated with the UE, where the downlink STO is based on the first downlink signal, and receive, based on transmitting the indication of the downlink STO, a second downlink signal that is equalized in accordance with a third estimated channel, where the third estimated channel is based on both the downlink STO associated with the UE and the uplink STO associated with the UE.

Another UE for wireless communications is described. The UE may include means for receiving, from a network entity, a first downlink signal that is equalized in accordance with a second estimated channel, where the second estimated channel is based on a first estimated channel and an uplink STO associated with the UE, means for transmitting an indication of a downlink STO associated with the UE, where the downlink STO is based on the first downlink signal, and means for receiving, based on transmitting the indication of the downlink STO, a second downlink signal that is equalized in accordance with a third estimated channel, where the third estimated channel is based on both the downlink STO associated with the UE and the uplink STO associated with the UE.

A non-transitory computer-readable medium storing code for wireless communications is described. The code may include instructions executable by one or more processors to receive, from a network entity, a first downlink signal that is equalized in accordance with a second estimated channel, where the second estimated channel is based on a first estimated channel and an uplink STO associated with the UE, transmit an indication of a downlink STO associated with the UE, where the downlink STO is based on the first downlink signal, and receive, based on transmitting the indication of the downlink STO, a second downlink signal that is equalized in accordance with a third estimated channel, where the third estimated channel is based on both the downlink STO associated with the UE and the uplink STO associated with the UE.

In some examples of the method, UEs, and non-transitory computer-readable medium described herein, the second estimated channel may be based on a first phase correcting factor and the first phase correcting factor may be based on the uplink STO.

In some examples of the method, UEs, and non-transitory computer-readable medium described herein, the third estimated channel may be an estimate of an actual downlink channel used to receive the second downlink signal, the third estimated channel may be based on a second phase correcting factor, and the second phase correcting factor may be based on the downlink STO.

Some examples of the method, UEs, and non-transitory computer-readable medium described herein may further include operations, features, means, or instructions for receiving a request for the UE to indicate the downlink STO of the UE, where transmitting the indication of the downlink STO may be based on the request.

In some examples of the method, UEs, and non-transitory computer-readable medium described herein, the request and the first downlink signal may be received as part of a same downlink transmission.

In some examples of the method, UEs, and non-transitory computer-readable medium described herein, the request may be received according to a periodic or aperiodic rate of reception.

In some examples of the method, UEs, and non-transitory computer-readable medium described herein, the request may be received via a physical layer at the UE.

Some examples of the method, UEs, and non-transitory computer-readable medium described herein may further include operations, features, means, or instructions for transmitting a recommendation to update the downlink STO based on the second downlink signal.

In some examples of the method, UEs, and non-transitory computer-readable medium described herein, the recommendation may be based on whether the second downlink signal may be associated with an aggregated phase difference across samples received in a frequency domain.

In some examples of the method, UEs, and non-transitory computer-readable medium described herein, the recommendation may be transmitted via an uplink control channel.

Some examples of the method, UEs, and non-transitory computer-readable medium described herein may further include operations, features, means, or instructions for receiving, from the network entity, a third downlink signal that may be equalized in accordance with the second estimated channel, where the second estimated channel may be based on the first estimated channel and the uplink STO associated with the UE, transmitting a second indication of an updated downlink STO associated with the UE, where the updated downlink STO may be based on the third downlink signal, and receiving, based on transmitting the second indication of the downlink STO, a fourth downlink signal that may be equalized in accordance with a fourth estimated channel, where the fourth estimated channel may be based on both the updated downlink STO associated with the UE and the uplink STO associated with the UE.

Some examples of the method, UEs, and non-transitory computer-readable medium described herein may further include operations, features, means, or instructions for receiving the third downlink signal may be based on transmission of a recommendation to update the downlink STO or reception of a request for the UE to update the downlink STO.

In some examples of the method, UEs, and non-transitory computer-readable medium described herein, the third downlink signal may be a repetition of the first downlink signal.

Some examples of the method, UEs, and non-transitory computer-readable medium described herein may further include operations, features, means, or instructions for estimating the downlink STO based on the first downlink signal, where transmission of the indication may be based on the estimation.

Some examples of the method, UEs, and non-transitory computer-readable medium described herein may further include operations, features, means, or instructions for estimating the downlink STO may be based on reception of a request from the network entity.

Some examples of the method, UEs, and non-transitory computer-readable medium described herein may further include operations, features, means, or instructions for refraining from equalizing the second downlink signal based on the second downlink signal being equalized in accordance with the third estimated channel.

Some examples of the method, UEs, and non-transitory computer-readable medium described herein may further include operations, features, means, or instructions for multiplying the second downlink signal by an inverse of a phase correcting factor based on the second downlink signal being equalized in accordance with the third estimated channel.

Some examples of the method, UEs, and non-transitory computer-readable medium described herein may further include operations, features, means, or instructions for receiving a control message indicative of the phase correcting factor.

Some examples of the method, UEs, and non-transitory computer-readable medium described herein may further include operations, features, means, or instructions for estimating the phase correcting factor.

In some examples of the method, UEs, and non-transitory computer-readable medium described herein, the first downlink signal may be further based on the downlink STO associated with the UE.

In some examples of the method, UEs, and non-transitory computer-readable medium described herein, the indication of the downlink STO may be transmitted via an uplink control channel.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for transmitter (Tx) equalization based on sampling time offsets (STOs) associated with a user equipment (UE) in accordance with one or more aspects of the present disclosure.

FIG. 2 shows an example of a wireless communications system that supports techniques for Tx equalization based on STOs associated with a UE in accordance with one or more aspects of the present disclosure.

FIG. 3 shows an example of a process flow that supports techniques for Tx equalization based on STOs associated with a UE in accordance with one or more aspects of the present disclosure.

FIGS. 4 and 5 show block diagrams of devices that support techniques for Tx equalization based on STOs associated with a UE in accordance with one or more aspects of the present disclosure.

FIG. 6 shows a block diagram of a communications manager that supports techniques for Tx equalization based on STOs associated with a UE in accordance with one or more aspects of the present disclosure.

FIG. 7 shows a diagram of a system including a device that supports techniques for Tx equalization based on STOs associated with a UE in accordance with one or more aspects of the present disclosure.

FIGS. 8 and 9 show block diagrams of devices that support techniques for Tx equalization based on STOs associated with a UE in accordance with one or more aspects of the present disclosure.

FIG. 10 shows a block diagram of a communications manager that supports techniques for Tx equalization based on STOs associated with a UE in accordance with one or more aspects of the present disclosure.

FIG. 11 shows a diagram of a system including a device that supports techniques for Tx equalization based on STOs associated with a UE in accordance with one or more aspects of the present disclosure.

FIGS. 12 and 13 show flowcharts illustrating methods that support techniques for Tx equalization based on STOs associated with a UE in accordance with one or more aspects of the present disclosure.

### DETAILED DESCRIPTION

Some wireless communications system may support data equalization for downlink data, which may be performed by a receiver (Rx) device, such as a user equipment (UE). In such cases, the UE may receive a downlink signal and may equalize the downlink signal (e.g., based on a downlink sampling time offset (STO) associated with the UE). However, performing data equalization at the UE (e.g., the Rx device), which may be referred to as Rx data equalization, may result in increased power consumption at the UE. Accordingly, in some cases, data equalization for downlink data may be performed at a transmitter (Tx) device, such as a network entity, which may be referred to as Tx data equalization. In such cases, a reciprocity scenario may exist between the UE and the network entity in which downlink transmissions by the network entity may experience a same channel as uplink transmissions by the UE. Thus, the network entity may be capable of estimating a downlink channel based on an uplink channel (e.g., and based on the reciprocity) and may perform Tx data equalization of a downlink signal (e.g., data) based on the estimation of the downlink channel in accordance with the uplink channel.

However, even in reciprocity scenarios, one or more conditions at the UE may result in differences in the uplink channel and the downlink channel, such that the network entity may be inaccurately estimating the downlink channel based on the uplink channel (e.g., due to the differences). Additionally, or alternatively, because the UE may not be associated with a same radio frequency (RF) chain as the network entity, a downlink STO associated with the UE may be different than an uplink STO associated with the UE. Thus, even if the downlink channel and the uplink channel are approximately the same, the impacts of the channels on signaling may be different, resulting in the network entity inaccurately estimating the downlink channel based on the uplink channel.

Accordingly, techniques described herein enable a network entity to perform Tx data equalization of downlink signals based on both a downlink STO and an uplink STO associated with a UE. For example, a UE may transmit, to a network entity, an uplink signal via an actual uplink channel (e.g., H_{UL}). Thus, the network entity may estimate the actual uplink channel to generate a first estimated channel (e.g., Ĥ_{UL}) and may also estimate an uplink STO associated with the UE 115-b based on the uplink signal. The UE may estimate a first phase correcting factor associated with the uplink STO (e.g., \hat{B}_{UL-STO}) and may extract a second estimated channel (e.g., Ĥ) from the first estimated channel (e.g., Ĥ_{UL}) based on the first phase correcting factor (e.g., Aut=\hat{B}_{UL-STO}·Ĥ). In other words, the network entity may remove the uplink STO from the first estimated channel (e.g., Ĥ_{UL}) to generate the second estimated channel (e.g., Ĥ). Thus, the network entity may equalize a first downlink signal in accordance with the second estimated channel based on removal of the uplink STO and may transmit the first downlink signal (e.g., equalized first downlink signal) to the UE.

The UE may receive the first downlink signal and may estimate a downlink STO associated with the UE based on the first downlink signal. Additionally, the UE may transmit an indication of the downlink STO to the network entity, such that the network entity may generate a third estimated channel (e.g., Ĥ_{DL}) based on the downlink STO. That is, the network entity may estimate a second phase correcting factor associated with the downlink STO (e.g., \hat{B}_{DL-STO}) and may apply the second phase correcting factor to the second estimated channel (e.g., Ĥ) to generate the third estimated channel (e.g., Ĥ_{DL} where Ĥ_{DL}=B_{DL-STO}·Ĥ). In other words, the network entity may remove the downlink STO from the second estimated channel, which is already free of uplink STO, such that the third estimated channel is free of the downlink STO and the uplink STO. Thus, the network entity may equalize a second downlink signal in accordance with the third estimated channel and may transmit the second downlink signal (e.g., equalized second downlink signal) to the UE. Because the second downlink signal is equalized in accordance with the third estimated channel that is free of the downlink STO and the uplink STO, the UE may refrain from performing Rx equalization of the second downlink signal, thus saving power at the UE.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to techniques for Tx equalization based on STOs associated with a UE.

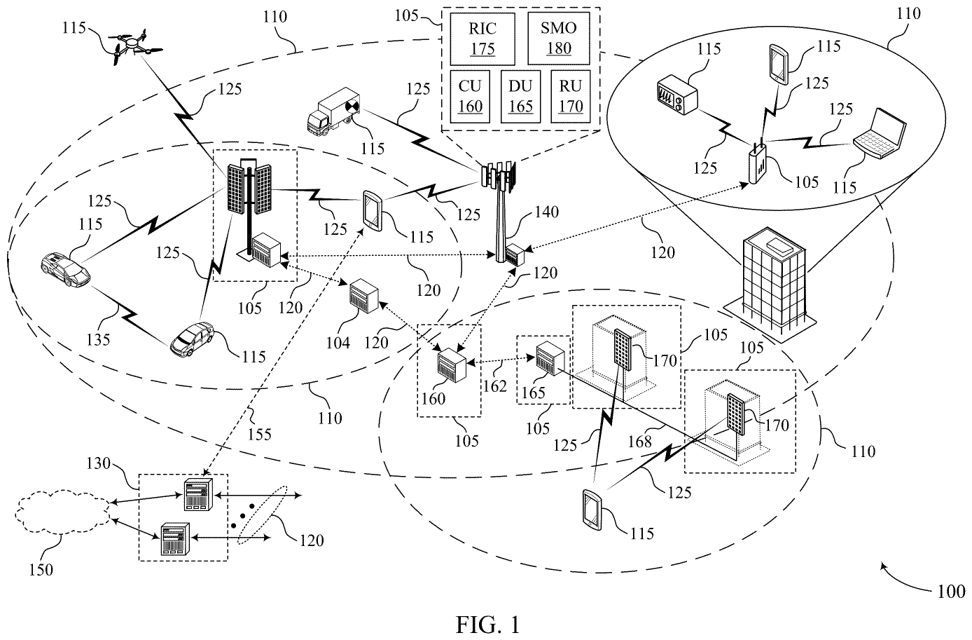

FIG. 1 shows an example of a wireless communications system 100 that supports techniques for Tx equalization based on STOs associated with a UE in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for Tx equalization based on STOs associated with a UE as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may support techniques that enable a network entity 105 to perform Tx data equalization of downlink signals based on both a downlink STO and an uplink STO associated with a UE 115. For example, the UE 115 may transmit, to the network entity 105, an uplink signal via an actual uplink channel (e.g., H_{UL}). Thus, the network entity 105 may estimate the actual uplink channel to generate a first estimated channel (e.g., Ĥ_{UL}) and may also estimate an uplink STO associated with the UE 115 based on the uplink signal. Additionally, the UE 115 may estimate a first phase correcting factor associated with the uplink STO (e.g., \hat{B}_{UL-STO}) and may extract a second estimated channel (e.g., Ĥ) from the first estimated channel (e.g., Ĥ_{UL}) based on the first phase correcting factor (e.g., Ĥ_{UL}=\hat{B}_{UL-STO}·Ĥ). In other words, the network entity 105 may remove the uplink STO from the first estimated channel (e.g., Ĥ_{UL}) to generate the second estimated channel (e.g., Ĥ). Thus, the network entity 105 may equalize a first downlink signal in accordance with the second estimated channel based on removal of the uplink STO and may transmit the first downlink signal (e.g., equalized first downlink signal) to the UE 115.

The UE 115 may receive the first downlink signal and may estimate a downlink STO associated with the UE 115 based on the first downlink signal. Additionally, the UE 115 may transmit an indication of the downlink STO to the network entity 105, such that the network entity 105 may generate a third estimated channel (e.g., Ĥ_{DL}) based on the downlink STO. That is, the network entity 105 may estimate a second phase correcting factor associated with the downlink STO (e.g., \hat{B}_{DL-STO}) and may apply the second phase correcting factor to the second estimated channel (e.g., Ĥ) to generate the third estimated channel (e.g., Ĥ_{DL} where Ĥ_{DL}=\hat{B}_{DL-STO}·Ĥ). In other words, the network entity 105 may remove the downlink STO from the second estimated channel, which is already free of uplink STO, such that the third estimated channel is free of the downlink STO and the uplink STO. Thus, the network entity 105 may equalize a second downlink signal in accordance with the third estimated channel and may transmit the second downlink signal (e.g., equalized second downlink signal) to the UE 115. Because the second downlink signal is equalized in accordance with the third estimated channel that is free of the downlink STO and the uplink STO, the UE 115 may refrain from performing Rx equalization of the second downlink signal, thus saving power at the UE 115.

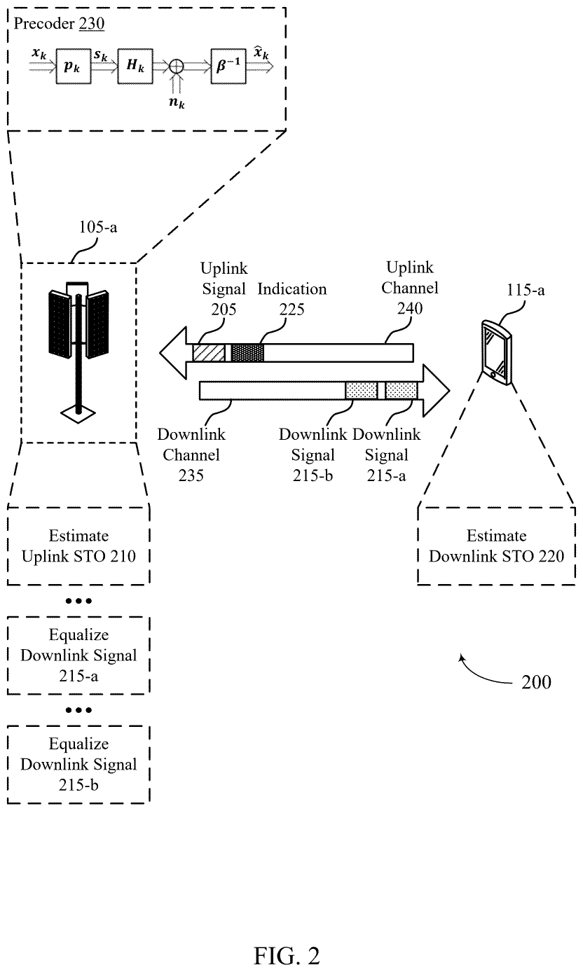

FIG. 2 shows an example of a wireless communications system 200 that supports techniques for Tx equalization based on STOs associated with a UE in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

Some wireless communications systems, such as the wireless communications system 200, may support data equalization of downlink data (e.g., at the downlink). In such cases, the data equalization of the downlink data may be performed at an Rx device, such as the UE 115-a, which may be referred to as Rx data equalization (e.g., Rx equalization). In such cases, the UE 115-a may receive a downlink signal 215 (e.g., downlink data) and may equalize the downlink signal 215 (e.g., based on a downlink STO associated with the UE 115-a). However, performing Rx data equalization at the UE 115-a may result in increased power consumption at the UE 115-a. Accordingly, in some cases, the data equalization of the downlink data may be shifted to be performed at a Tx-side, which may remove Rx data equalization complexity from an overall complexity of the UE 115-a (e.g., allow the UE 115-a to refrain from performing Rx data equalization), thus reducing power consumption. That is, a Tx device, such as the network entity 105-a, may equalize the downlink signal 215 prior to transmission, which may be referred to as Tx data equalization (e.g., Tx equalization), such that the UE 115-a may not (e.g., is exempted from) perform Rx data equalization (e.g., including channel estimation and demodulation) prior to a decoding process, thus increasing power savings of the UE 115-a.

In such cases, to enable Tx data equalization, the network entity 105-a may utilize or rely on information associated with a downlink channel 235 between the network entity 105-a and the UE 115-a prior to transmission of the downlink signal 215. Thus, Tx equalization may be supported when a reciprocity scenario (e.g., one or more reciprocity conditions) exists between the UE 115-a and the network entity 105-a, such that the network entity 105-a may be able to estimate (e.g., accurately estimate) the downlink channel 235 (e.g., and perform Tx data equalization) based on an estimation of an uplink channel 240 between the UE 115-a and the network entity 105-a. In other words, the reciprocity scenario (e.g., the one or more reciprocity conditions) may exist when a downlink signal 215 (e.g., downlink transmission) transmitted by the network entity 105-a experiences a same channel (e.g., channel conditions) as an uplink signal 205 transmitted by the UE 115-a (e.g., and visa-versa). Thus, the network entity 105-a may be able to (e.g., capable of) estimate the downlink channel 235 based on an estimation of the uplink channel 240 over which the uplink signal 205 is received, and may perform Tx data equalization of the downlink signal 215 based on the estimation of the estimation of the downlink channel 235.

However, even in a reciprocity scenario, each UE 115 may be associated with one or more conditions that may impact the reciprocity scenario and may cause a downlink signal 215 transmitted by the network entity 105-a to not experience a same channel as an uplink signal 205 transmitted by the UE 115-a (e.g., may cause a mismatch between the uplink channel and the downlink channel). Thus, the network entity 105-a may not be able to estimate the downlink channel 235 based on an estimation of the uplink channel 240 or may incorrectly estimate the downlink channel 235 based on the estimation of the uplink channel 240 (e.g., the estimation of the downlink channel 235 may not be accurate).

Additionally, or alternatively, the UE 115-a may support one or more first RF chains for reception and one or more second RF chains for transmission, where the one or more first RF chains may be different than the one or more second RF chains. Thus, in some cases (e.g., when each antenna at the UE 115-a is associated with a different non-common STO), the UE 115-a may be associated with a different downlink STO 220 than an uplink STO 210 (e.g., a different STO at a downlink transmission than at an uplink transmission). In such cases, even if the downlink channel 235 and the uplink channel 240 are the same, an influence of the downlink channel 235 on a downlink signal 215 may be different than an influence of the uplink channel 240 on an uplink signal 205 based on the difference between the downlink STO 220 and the uplink STO 210. Thus, a reciprocity scenario may not exist due to the difference between the downlink STO 220 and the uplink STO 210 impacting how each channel impacts respective transmissions (e.g., even though the downlink channel and the uplink channel may be at least approximately the same from a reciprocity perspective).

In some cases, the UE 115-a may support an STO corrector associated with each downlink reception to account for (e.g., compensate, correct for) the difference between the downlink STO 220 and the uplink STO 210 (e.g., compensate for the channel mismatch that the downlink STO 220 and uplink STO 210 cause). However, the UE 115-a may be a low complexity device (e.g., complexity less than a threshold), such as a battery limited device (e.g., extended reality (XR) glasses, internet-of-things (IoT) device, reduced capability (RedCap) device), such than an STO corrector may increase power consumption (e.g., significantly increase power consumption, increase power consumption above a threshold).

Accordingly, techniques described herein may enable a network entity 105, such as the network entity 105-a, to perform Tx data equalization of downlink signals 215 based on a downlink STO 220 and an uplink STO 210 associated with a UE 115, such as the UE 115-a, such that the UE 115-a may refrain from performing (e.g., may not need to perform) STO correction of the downlink signals 215 (e.g., clean equalized downlink signals 215), thus saving power.

For example, considering the different downlink STO 220 (e.g., STO in downlink reception) and uplink STO 210 (e.g., STO in uplink transmission) associated with the UE 115-a and considering one or more channel reciprocity conditions (e.g., a channel reciprocity assumption that a downlink channel 235 between the network entity 105-a and the UE 115-a is the same an uplink channel 240 between the UE 115-a and the network entity 105-a), the uplink channel 240 (e.g., overall, or actual, uplink channel), H_{UL}, and the downlink channel 235 (e.g., overall, or actual, downlink channel), H_{dl}, may be represented according to the following Equations 1 and 2:

$${H}_{U L} = {H}^{T} \cdot {B}_{UL - S T O} \qquad ( 1 )$$

$${H}_{DL} = {B}_{DL - S T O} \cdot H \qquad ( 2 )$$

where H may be an R×T matrix representing an actual channel (e.g., free of STO) between the UE 115-a and the network entity 105-b, B_{UL-STO} may be a first R×R matrix representing an STO impairment resulting from one or more uplink RF chains associated with the UE 115-a (e.g., UL transmission RF chains), and B_{DL-STO} may be a second R×R matrix representing an STO impairment resulting from one or more downlink RF chains associated with the UE 115-a (e.g., UL transmission RF chains. In other words, B_{UL-STO}, which may similarly be referred to as a first phase correcting factor, may be associated with (e.g., based on) the uplink STO 210 and B_{DL-STO}, which may similarly be referred to as a second phase correcting factor, may be associated with (e.g., based on) the downlink STO 220. Additionally, R may represent a quantity of antennas at the UE 115-a, which may be referred to as Rx antennas, and T may represent a quantity of antennas at the network entity 105-a, which may be referred to as Tx antennas.

Additionally, in a case of a non-common STO among different Tx antennas and Rx antennas associated with the UE 115-a, each Tx antenna and Rx antenna associated with the UE 115-a may be associated with a different STO (e.g., different downlink STO 220 and different uplink STO 210, respectively). Thus, a frequency domain representation of B_{UL-STO} and B_{DL-STO} may be represented as two diagonal matrixes, where each entry at a diagonal consists of a phasor, as represented according to the following Equations 3 and 4:

$${B}_{U L - S T O} [ k ] = [ \begin{matrix}{e}^{- j ( {θ}_{i}^{U} ) k} & … & 0 \\ … & ⋱ & … \\ 0 & … & {e}^{- j ( {θ}_{k}^{U} ) k}\end{matrix} ] \qquad ( 3 )$$

$${B}_{D L - S T O} [ k ] = [ \begin{matrix}{e}^{- j ( {θ}_{i}^{D} ) k} & … & 0 \\ … & ⋱ & … \\ 0 & … & {e}^{- j ( {θ}_{k}^{D} ) k}\end{matrix} ] \qquad ( 4 )$$

where

$${θ}_{i}^{U} \cdot k and {θ}_{i}^{D} \cdot k$$

may represent angles that are added to k^{th} subcarrier at the i^{th} Tx antenna and Rx antenna, respectively, at the UE 115-a. Thus, the network entity 105-a may be capable of calculating, or estimating, B_{DL-STO} if the network entity 105-a is provided with, or estimates,

$$[ {θ}_{i}^{D} … {θ}_{R}^{D} ] ,$$

which may represent the downlink STO 220. As such, in some cases, the UE 115-a may provide (e.g., transmit) an indication of

$$[ {θ}_{i}^{D} … {θ}_{R}^{D} ]$$

(e.g., via an uplink transmission after

$$[ {θ}_{i}^{D} … {θ}_{R}^{D} ]$$

is estimated by the UE 115-a), such that the network entity 105-a may be capable of performing Tx data equalization (e.g., designing a Tx equalizer) with respect to the downlink channel (e.g., H_{DL}, where H_{DL}=B_{DL-STO}·H) instead of with respect to H. Doing so may enable the UE 115-a to receive a downlink signal 215 that is free of both uplink STO 210 and downlink STO 220 (e.g., a clean downlink signal 215), such that the UE 115-a may refrain from performing STO correction of the downlink signal 215.

For example, as depicted in FIG. 2, the UE 115-a may transmit, to the network entity 105-a, an uplink signal 205 via an actual uplink channel 240, H_{UL} and the network entity 105-a may estimate the actual uplink channel 240, H_{UL}, to generate a first estimated channel, Ĥ_{UL}. Additionally, the network entity 105-a may estimate the uplink STO 210 associated with the UE 115-a (e.g., uplink STO 210 that resulted from one or more Tx antennas at the UE 115-a) based on the uplink signal 205 (e.g., and/or based on the first estimated uplink channel, Ĥ_{UL}). In such cases, the network entity 105-a may estimate the uplink STO 210 using one or more first methods for estimating STO. For example, the network entity 105-a may evaluate an accumulated phase difference of the first estimated channel, Ĥ_{UL}, across the frequency domain and may extract, from the accumulated phase difference, the uplink STO 210

$$( e . g . , [ {θ}_{i}^{U} … {θ}_{R}^{U} ] ) .$$

Additionally, the network entity 105-a may estimate the first phase correcting factor, B_{UL-STO}, associated with the uplink STO 210 (e.g., based on the uplink STO 210) to generate (e.g., estimate) a first estimated phase correcting factor, \hat{B}_{UL-STO}, and may extract a second estimated channel, Ĥ, from the first estimated channel, H_{UL}, based on the first estimated phase correcting factor, \hat{B}_{UL-STO}. In other words, the network entity 105-a may extract (e.g., estimate) the second estimated channel, Ĥ, (e.g., an estimate of H) and the first estimated phase correcting factor, \hat{B}_{UL-STO}, (e.g., an estimate of B_{UL-STO}) from the first estimated channel, Ĥ_{UL}, (e.g., an estimate of H_{UL}) by removing an influence, or impact, of the uplink STO 210. In such cases, the extraction may be represented according to the following conversion of Equation 1 (e.g., H_{UL}=H^{T}·B_{UL-STO}) into Equation 5

$$( e . g . , \hat{H} = {( {\hat{H}}_{U L} {\hat{B}}_{U L - S T O}^{- 1} )}^{T} ) :$$

$${H}_{U L} = {H}^{T} \cdot {B}_{U L - S T O} \to \hat{H} = {( {\hat{H}}_{U L} {\hat{B}}_{U L - S T O}^{- 1} )}^{T} \qquad ( 5 )$$

In some cases, the network entity 105-a may update the estimation (e.g., estimation of H represented by Ĥ) periodically or aperiodically based on one or more conditions (e.g., aging, one or more system thresholds, or requirements, or both).

As such, the network entity 105-a may equalize a downlink signal 215-a (e.g., downlink transmission, downlink data) with respect to (e.g., in accordance with) the second estimated channel, Ĥ (e.g., and still without consideration of the downlink STO 220). In other words, the network entity 105-a may perform Tx data equalization of the downlink signal 215-a with respect to the second estimated channel, Ĥ (e.g., considering the uplink STO 210 associated with the UE 115-a). In such cases, the downlink signal 215-a may still be effected by (e.g., associated with) the downlink STO 220 associated with the UE 115-a. In other words, the downlink signal 215-a may be clean (e.g., free) of raw channel effects (e.g., effects due to Ĥ) and effects due to the uplink STO 210, but may not be clean of effects due to the downlink STO 220 (e.g., based on the Tx data equalization).

In some cases, a downlink transmission carrying the downlink signal 215-a may additionally include, in the same downlink transmission, a request (e.g., over physical downlink control channel (PDCCH)) for the UE 115-a to indicate information associated with the downlink STO 220, as estimated by the UE 115-a. Additionally, or alternatively, the request may be for an updated indication of the information associated with the downlink STO 220 (e.g., over a physical (PHY) layer-level). In other words, the network entity 105-a may request an updated downlink STO 220. In such cases the request for the updated indication may be transmitted by the network entity 105-a according to a periodic or aperiodic rate (e.g., according to system thresholds).

Thus, the UE 115-a may receive the downlink signal 215-a (e.g., equalized downlink signal 215, downlink signal 215-a with Tx equalizer) and may estimate the downlink STO 220 that resulted from one or more Rx antennas at the UE 115-a (e.g., using one of one or more downlink pilots, or data aided estimations). In such cases, the UE 115-a may estimate the downlink STO 220 using one or more second methods for estimating STO (e.g., the same as or different than the one or more first methods for estimating STO). For example, as described with reference to the network entity 105-a estimating the uplink STO 210, the UE 115-a may evaluate an accumulated phase difference of the actual downlink channel 235, H_{DL}, across the frequency domain and may extract, from the accumulated phase difference, the downlink STO 220

$$( e . g . , [ {θ}_{i}^{D} … {θ}_{R}^{D} ] ) .$$

In such cases, the UE 115-a may refrain from (e.g., may not need to) perform channel estimation to estimate the downlink STO 220. In some examples, the UE 115-a may estimate the downlink STO 220 based on (e.g., every time) the network entity 105-a requesting an updated estimation (e.g., an updated indication).

Additionally, the UE 115-a may transmit, to the network entity 105-a (e.g., over a physical uplink control channel (PUCCH), an indication 225 of the downlink STO 220

$$( e . g . , [ {θ}_{i}^{D} … {θ}_{R}^{D} ] )$$

estimated by the UE 115-a. In other words, the UE 115-a may share the information associated with the downlink STO 220 with the network entity 105-a. As such, the network entity 105-a may be capable of performing Tx data equalization with respect to the downlink STO 220 based on receiving the indication 225. For example, the network entity 105-a may estimate the second phase correcting factor, B_{DL-STO}, associated with downlink STO 220 (e.g., based on the downlink STO 220 estimated by the UE 115-a) to generate (e.g., estimate) a second estimated phase correcting factor, \hat{B}_{DL-STO}, and may apply the second estimated phase correcting factor, \hat{B}_{DL-STO}, to the second estimated channel, Ĥ, to generate a third estimated channel, Ĥ_{DL}. In such cases, the third estimated channel may be an estimate of the actual downlink channel 235, H_{DL}, between the network entity 105-a and the UE 115-a.

Thus, the network entity 105-a may equalize a downlink signal 215-b with respect to (e.g., in accordance with) the third estimate channel, Ĥ_{DL} (e.g., or ρĤ_{DL}, as described herein). In other words, the network entity 105-a may perform Tx data equalization of the downlink signal 215-b with respect to the third estimate channel, Ĥ_{DL} (e.g., considering the downlink STO 220 associated with the UE 115-a). In such cases, the downlink signal 215-b may be clean of (e.g., free of) the raw channel effect (e.g., effects due to Ĥ), the effects due to the uplink STO 210, and the effects due to the downlink STO 220. Thus, the UE 115-a may refrain from performing (e.g., may not need to perform) Rx data equalization, channel estimation, or STO removal after (e.g., at) reception of the downlink signal 215-b (e.g., prior to decoding). In other words, the UE 115-a may avoid performing downlink STO correction based on receiving the downlink signal 215-b (e.g., clean equalized downlink signal 215-b) that is free of channel and STO influence, rather than cancelling the downlink STO (e.g., performing downlink STO correction) for each downlink slot.

In some cases, the UE 115-a may transmit, to the network entity 105-a (e.g., over the PUCCH), a recommendation to update the downlink STO 220. For example, the UE 115-a may determine whether to update the downlink STO 220 based on whether the downlink signal 215-b (e.g., received signal) is associated with an aggregated phase difference across samples received in the frequency domain. Additionally, or alternatively, to update the downlink STO 220 (e.g., based on either a request by the network entity 105-a or a recommendation by the UE 115-a, as described herein), the network entity 105-a and the UE 115-a may repeat a portion of the aforementioned process, including equalization of the downlink signal 215-a in accordance with the second estimated channel through transmission of the downlink signal 215-b equalized in accordance with the updated downlink STO 220. In such cases, the updating may be performed (e.g., based on request or recommendation) according to a periodic or aperiodic rate to track variations in the uplink STO 210, the downlink STO 220, or both.

In some cases, the network entity 105-a may equalize the downlink signal 215-a, the downlink signal 215-b, or both, in accordance with (e.g., using) Tx-linear minimum mean squared error (Tx-LMMSE) equalization, among other Tx data equalization methods (e.g., Tomlinson-Harashima precoding (THP)). That us, aided by channel knowledge, the network entity 105-a may implement (e.g., support) a precoder 230 than equalizes (e.g., aims at equalizing) a downlink signal prior to transmission. The precoder 230 (e.g., and Tx-LMMSE equalizer) may be designed based on an informed channel. In such cases, k may represent a frequency domain index, xx may present a transmitted data signal (e.g., the downlink signal 215-a or the downlink signal 215-b as transmitted by the network entity 105-a), sₖ may represent an output of the Tx-LMMSE equalizer, nₖ may represent additive noise at a receiver (e.g., at a receiver of the UE-a), yₖ may represent a received signal (e.g., the downlink signal 215-a or the downlink signal 215-b as received at the UE 115-a), \hat{x}ₖ may represent estimated transmitted data, ρₖ may represent the Tx-LMMSE equalizer, Hₖ may represent a channel response, and β may represent a scaling factor (e.g., to apply a power constraint). As such, ρₖ (Hₖ) and β may be calculated according to the following Equations 6 and 7:

$${ρ}_{k} ( {H}_{k} ) = {β ( {H}_{k}^{H} {H}_{k} + \frac{trace ( {R}_{n n} )}{E} I )}^{- 1} , \qquad ( 6 )$$

$$where \tilde{p} = {( {H}_{k}^{H} {H}_{k} + \frac{trace ( {R}_{n n} )}{E} I )}^{- 1}$$

$$β = \sqrt{\frac{E}{mean ( trace ( \tilde{p} {\tilde{p}}^{H} ) )}} \qquad ( 7 )$$

Thus, as described herein, the network entity 105-a may generate ρₖ(Ĥₖ) associated with the downlink signal 215-a and may generate ρₖ(Ĥ_{DL}_{ₖ}) associated with the downlink signal 215-b, where H_{DL}=B_{DL-STO}·H. As such, in some cases, the UE 115-a may cancel out an influence of the scaling factor, β, by multiplying a received signal (e.g., the downlink signal 215-a or the downlink signal 215-b as received at the UE 115-a) by an inverse of the scaling factor, β⁻¹. In such cases, the UE 115-a may estimate the scaling factor or may receive (e.g., over the PDCCH) an indication of the scaling factor (e.g., scaling factor information).

It is understood that, as described herein, a variable with an accent, or symbol, \hat{ } indicates that the variable is an estimation. That is, Ĥ_{UL} is an estimation of H_{UL}, for example. Further, variables with and without the accent, \hat{ }, may be used interchangeably.

Though described in the context of the downlink STO 220 associated with the UE 115-a and the uplink STO associated with the UE 115-a, this is not to be regarded as a limitation of the present disclosure. In this regard, the techniques described herein may not be limited to a scenario in which the network entity 105-a performs a calibration procedure to reduce, or eliminate, STO (e.g., downlink and uplink) associated with the network entity 105-a and may be applied to other scenarios, such as when the network entity 105-a may consider the STO (e.g., downlink and uplink) associated with the network entity 105-a (e.g., the network entity 105-a does not perform the calibration procedure).

Further, though described it the context of network entity 105-a and a UE 115-a, this is not to be regarded as a limitation of the present disclosure. In this regard, the network entity 105-a is merely an example of a Tx device and the UE 115-a is merely an example of a Rx device, such that any type or combination of types of wireless devices may be considered with regarding the techniques described herein.

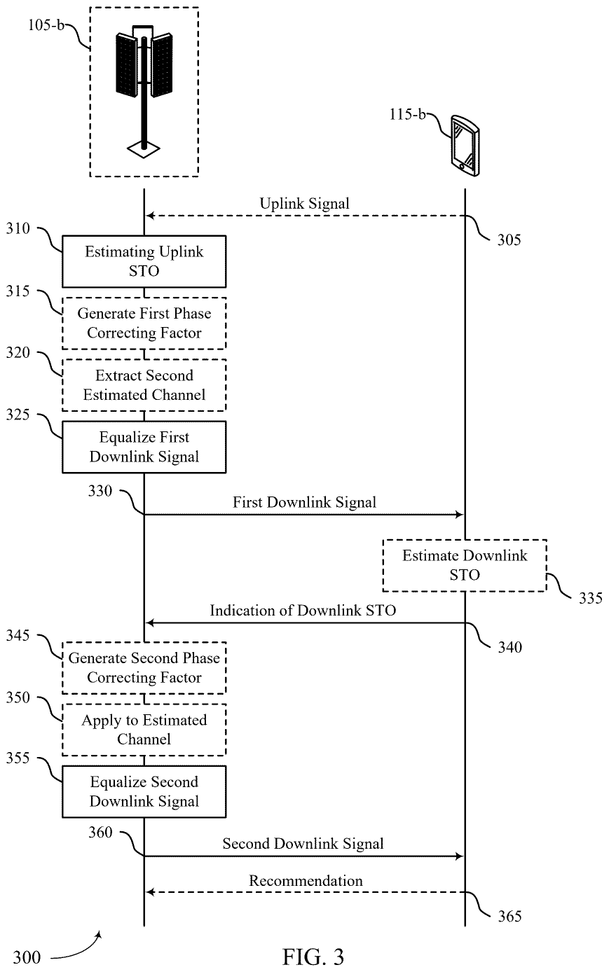

FIG. 3 shows an example of a process flow 300 that supports techniques for Tx equalization based on STOs associated with a UE in accordance with one or more aspects of the present disclosure. In some cases, the process flow 300 may implement or be implemented by aspects of the wireless communications system 100, the wireless communications system 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be communicated in a different order than the example order shown, or the operations performed by the UE 115-b and the network entity 105-b may be performed in different orders or at different times. Some operations may also be omitted from the process flow 300, and other operations may be added to the process flow 300.

In some cases, at 305, the UE 115-b may transmit an uplink signal (e.g., uplink transmission, uplink message) to the network entity 105-b via an actual uplink channel (e.g., H_{UL}). In some cases, the network entity 105-b may estimate a first channel (e.g., Ĥ_{UL}), which may be referred to as a first estimate channel, based on the uplink signal (e.g., based on the actual uplink channel).

At 310, the network entity 105-b may estimate an uplink STO associated with the UE 115-b based on the uplink signal received from the UE 115-b. In some cases, the uplink STO may be removed from the first estimated channel to generate a second estimated channel (e.g., Ĥ). That is, at 315, the network entity 105-b may generate a first phase correcting factor (e.g., \hat{B}_{UL-STO}) associated with (e.g., based on) the uplink STO (e.g., estimated by the network entity 105-b) and, at 320, may extract the second estimated channel (e.g., Ĥ) from the first estimated channel (e.g., Ĥ_{UL}) based on (e.g., using) the first phase correcting factor (e.g., Ĥ_{UL}=\hat{B}_{UL-STO}·Ĥ).

Thus, at 325, the network entity 105-b may equalize a first downlink signal in accordance with the second estimated channel based on removal of the uplink sampling time offset from the first estimated channel and, at 330, may transmit the first downlink signal (e.g., the equalized first downlink signal) to the UE 115-b. In such cases, the first downlink signal may be based on a downlink STO associated with (e.g., include) the UE 115-b.

In some cases, the first downlink signal may be transmitted is a same downlink transmission as a request for the UE 115-b to indicate information associated with the downlink STO of the UE 115-b. In such cases, the request may be transmitted according to a periodic or aperiodic rate of transmission, via a physical layer at the UE 115-b, or both.

In some cases, at 335, the UE 115-b may estimate the downlink STO associated with the UE 115-b based on the first downlink signal and, at 340, may transmit, to the network entity 105-b (e.g., via an uplink control channel), an indication of the downlink STO. In some cases, transmission of the indication may be based on the request from the network entity 105-b.

In some examples, at 345, the network entity 105-b may generate a second phase correcting factor (e.g., \hat{B}_{DL-STO}) associated with (e.g., based on) the downlink STO and, at 350, may apply the second phase correcting factor (e.g., \hat{B}_{DL-STO}) to the second estimated channel (e.g., Ĥ) to generate a third estimated channel (e.g., Ĥ_{DL} where Ĥ_{DL}=\hat{B}_{DL-STO}·Ĥ). In such cases, the third estimated channel may be an estimate of an actual downlink channel (e.g., H_{DL}) to be used for transmission of a second downlink signal (e.g., a second equalized downlink signal). Additionally, the third estimated channel may be based on both the uplink STO and the downlink STO.

Thus, at 355, the network entity 105-b may equalize the second downlink signal in accordance with the third estimated channel and, at 660, may transmit the second downlink signal (e.g., the second equalized downlink signal) to the UE 115-b. In some cases, the UE 115-b may multiple the second downlink signal by an inverse of the second phase correcting factor based on the second downlink signal being equalized in accordance with the third estimated channel. In such cases, the phase correcting factor may be indicate to the UE 115-b via a control message (e.g., from the network entity 105-b) or may be estimated by the UE 115-b. Additionally, or alternatively, because the second downlink signal is equalized in accordance with the third estimated channel (e.g., free of uplink STO and downlink STO), the UE 115-b may refrain from equalizing the second downlink signal.

In some cases, at 365, the UE 115-b may transmit, to the network entity 105-b (e.g., via an uplink control channel), a recommendation for the network entity 105-b to update the downlink STO based on the second downlink signal. In such cases, the recommendation may be based on whether the second downlink signal is associated with an aggregated phase difference across samples received in a frequency domain.

In some examples, the network entity 105-b may repeat 330 through 360 based on reception of the recommendation, based on transmission of a second request for the UE 115-b to update the downlink STO, or both. That is, the network entity 105-b may transmit a third downlink signal that is equalized, by the network entity 105-b, in accordance with the second estimated channel, such that the UE 115-b may estimate an updated downlink STO associated with the UE 115-b based on the third downlink signal. In some examples, the third downlink signal may be a repetition of the first downlink signal. Thus, the UE 115-b may transmit, to the network entity 105-b, a second indication of the updated downlink STO associated with the UE 115-b and may equalize a fourth downlink signal in accordance with a fourth estimated channel. In such cases, the fourth estimated channel may be based on both the updated downlink STO associated with the UE 115-b and the uplink STO associated with the UE 115-b. Additionally, the network entity 105-b may transmit, to the UE 115-b, the fourth downlink signal (e.g., the equalized fourth downlink signal) based on equalization of the fourth downlink signal.

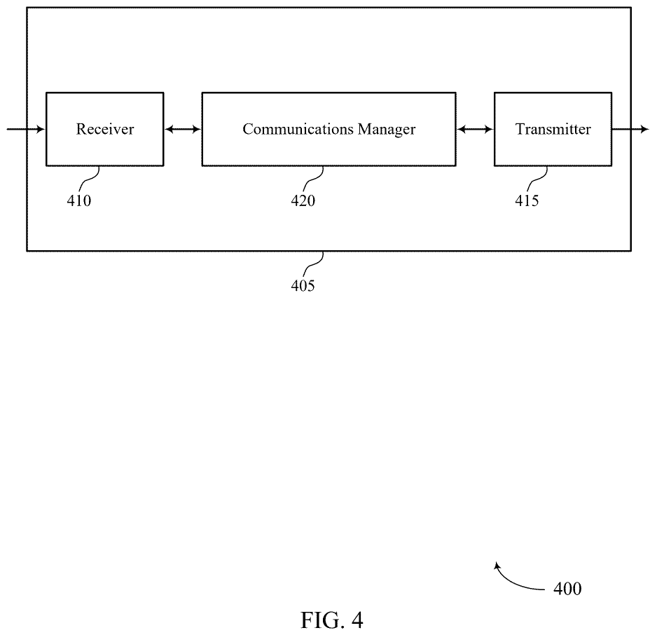

FIG. 4 shows a block diagram 400 of a device 405 that supports techniques for Tx equalization based on STOs associated with a UE in accordance with one or more aspects of the present disclosure. The device 405 may be an example of aspects of a network entity 105 as described herein. The device 405 may include a receiver 410, a Tx 415, and a communications manager 420. The device 405, or one or more components of the device 405 (e.g., the receiver 410, the Tx 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The Tx 415 may provide a means for outputting (e.g., transmitting, providing, conveying, sending) information generated by other components of the device 405. For example, the Tx 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the Tx 415 may support outputting information by transmitting signals via one or more antennas. Additionally, or alternatively, the Tx 415 may support outputting information by transmitting signals via one or more wired (e.g., electrical, fiber optic) interfaces, wireless interfaces, or any combination thereof. In some examples, the Tx 415 and the receiver 410 may be co-located in a transceiver, which may include or be coupled with a modem.

The communications manager 420, the receiver 410, the Tx 415, or various combinations or components thereof may be examples of means for performing various aspects of techniques for Tx equalization based on STOs associated with a UE as described herein. For example, the communications manager 420, the receiver 410, the Tx 415, or various combinations or components thereof may be capable of performing one or more of the functions described herein.

In some examples, the communications manager 420, the receiver 410, the Tx 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the Tx 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the Tx 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the Tx 415, or both. For example, the communications manager 420 may receive information from the receiver 410, send information to the Tx 415, or be integrated in combination with the receiver 410, the Tx 415, or both to obtain information, output information, or perform various other operations as described herein.

The communications manager 420 may support wireless communications in accordance with examples as disclosed herein. For example, the communications manager 420 is capable of, configured to, or operable to support a means for estimating an uplink STO associated with a UE based on uplink signal associated with the UE, where the uplink STO is removed from a first estimated channel to generate a second estimated channel. The communications manager 420 is capable of, configured to, or operable to support a means for equalizing a first downlink signal in accordance with the second estimated channel based on removal of the uplink STO from the first estimated channel. The communications manager 420 is capable of, configured to, or operable to support a means for transmitting the first downlink signal based on equalization of the first downlink signal. The communications manager 420 is capable of, configured to, or operable to support a means for receiving an indication of a downlink STO associated with the UE based on transmission of the first downlink signal. The communications manager 420 is capable of, configured to, or operable to support a means for equalizing a second downlink signal in accordance with a third estimated channel, where the third estimated channel is based on both the downlink STO associated with the UE and the uplink STO associated with the UE. The communications manager 420 is capable of, configured to, or operable to support a means for transmitting, to the UE, the second downlink signal based on equalization of the second downlink signal.

By including or configuring the communications manager 420 in accordance with examples as described herein, the device 405 (e.g., at least one processor controlling or otherwise coupled with the receiver 410, the Tx 415, the communications manager 420, or a combination thereof) may support techniques for Tx equalization based on UE STOs, which may result in reduced processing, reduced power consumption, and more efficient utilization of communication resources, among other advantages.

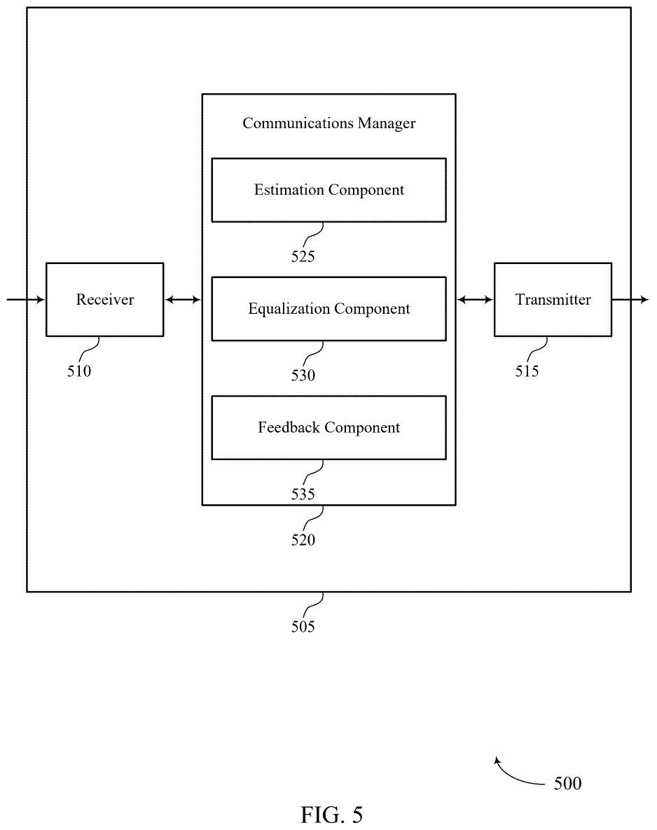

FIG. 5 shows a block diagram 500 of a device 505 that supports techniques for Tx equalization based on STOs associated with a UE in accordance with one or more aspects of the present disclosure. The device 505 may be an example of aspects of a device 405 or a network entity 105 as described herein. The device 505 may include a receiver 510, a Tx 515, and a communications manager 520. The device 505, or one or more components of the device 505 (e.g., the receiver 510, the Tx 515, the communications manager 520), may include at least one processor, which may be coupled with at least one memory, to support the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The Tx 515 may provide a means for outputting (e.g., transmitting, providing, conveying, sending) information generated by other components of the device 505. For example, the Tx 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the Tx 515 may support outputting information by transmitting signals via one or more antennas. Additionally, or alternatively, the Tx 515 may support outputting information by transmitting signals via one or more wired (e.g., electrical, fiber optic) interfaces, wireless interfaces, or any combination thereof. In some examples, the Tx 515 and the receiver 510 may be co-located in a transceiver, which may include or be coupled with a modem.

The device 505, or various components thereof, may be an example of means for performing various aspects of techniques for Tx equalization based on STOs associated with a UE as described herein. For example, the communications manager 520 may include an estimation component 525, an equalization component 530, a feedback component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the Tx 515, or both. For example, the communications manager 520 may receive information from the receiver 510, send information to the Tx 515, or be integrated in combination with the receiver 510, the Tx 515, or both to obtain information, output information, or perform various other operations as described herein.

The communications manager 520 may support wireless communications in accordance with examples as disclosed herein. The estimation component 525 is capable of, configured to, or operable to support a means for estimating an uplink STO associated with a UE based on uplink signal associated with the UE, where the uplink STO is removed from a first estimated channel to generate a second estimated channel. The equalization component 530 is capable of, configured to, or operable to support a means for equalizing a first downlink signal in accordance with the second estimated channel based on removal of the uplink STO from the first estimated channel. The equalization component 530 is capable of, configured to, or operable to support a means for transmitting the first downlink signal based on equalization of the first downlink signal. The feedback component 535 is capable of, configured to, or operable to support a means for receiving an indication of a downlink STO associated with the UE based on transmission of the first downlink signal. The equalization component 530 is capable of, configured to, or operable to support a means for equalizing a second downlink signal in accordance with a third estimated channel, where the third estimated channel is based on both the downlink STO associated with the UE and the uplink STO associated with the UE. The equalization component 530 is capable of, configured to, or operable to support a means for transmitting, to the UE, the second downlink signal based on equalization of the second downlink signal.

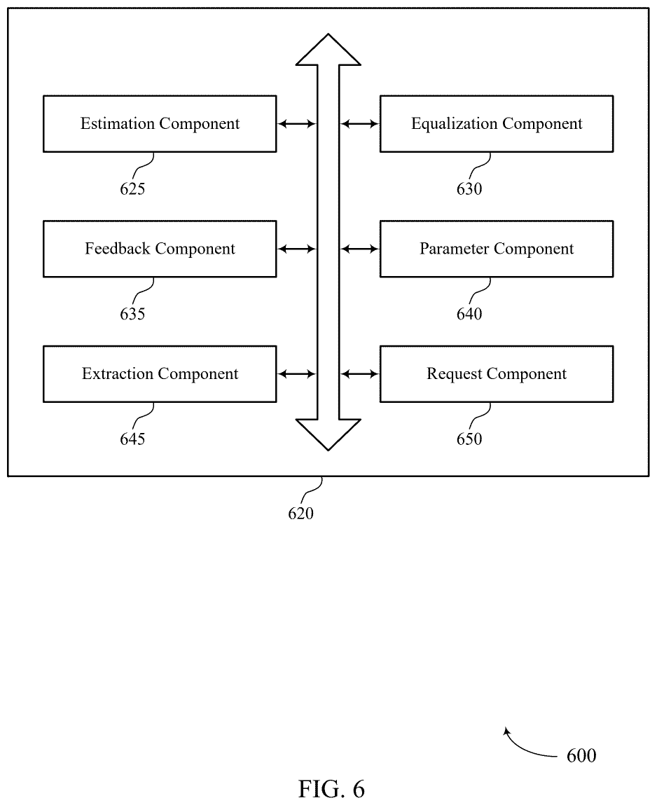

FIG. 6 shows a block diagram 600 of a communications manager 620 that supports techniques for Tx equalization based on STOs associated with a UE in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for Tx equalization based on STOs associated with a UE as described herein. For example, the communications manager 620 may include an estimation component 625, an equalization component 630, a feedback component 635, a parameter component 640, an extraction component 645, a request component 650, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 620 may support wireless communications in accordance with examples as disclosed herein. The estimation component 625 is capable of, configured to, or operable to support a means for estimating an uplink STO associated with a UE based on uplink signal associated with the UE, where the uplink STO is removed from a first estimated channel to generate a second estimated channel. The equalization component 630 is capable of, configured to, or operable to support a means for equalizing a first downlink signal in accordance with the second estimated channel based on removal of the uplink STO from the first estimated channel. In some examples, the equalization component 630 is capable of, configured to, or operable to support a means for transmitting the first downlink signal based on equalization of the first downlink signal. The feedback component 635 is capable of, configured to, or operable to support a means for receiving an indication of a downlink STO associated with the UE based on transmission of the first downlink signal. In some examples, the equalization component 630 is capable of, configured to, or operable to support a means for equalizing a second downlink signal in accordance with a third estimated channel, where the third estimated channel is based on both the downlink STO associated with the UE and the uplink STO associated with the UE. In some examples, the equalization component 630 is capable of, configured to, or operable to support a means for transmitting, to the UE, the second downlink signal based on equalization of the second downlink signal.

In some examples, to support removal of the uplink STO from the first estimated channel, the parameter component 640 is capable of, configured to, or operable to support a means for generating a first phase correcting factor based on the uplink STO estimated by the network entity. In some examples, to support removal of the uplink STO from the first estimated channel, the extraction component 645 is capable of, configured to, or operable to support a means for extracting, from the first estimated channel, the second estimated channel based on the first phase correcting factor.

In some examples, to support equalizing the second downlink signal, the parameter component 640 is capable of, configured to, or operable to support a means for generating a second phase correcting factor associated with the downlink STO. In some examples, to support equalizing the second downlink signal, the estimation component 625 is capable of, configured to, or operable to support a means for applying the second phase correcting factor to the second estimated channel to generate the third estimated channel, where the third estimated channel is an estimate of an actual downlink channel to be used for transmission of the second downlink signal. In some examples, to support equalizing the second downlink signal, the equalization component 630 is capable of, configured to, or operable to support a means for equalizing the second downlink signal in accordance with the third estimated channel.

In some examples, the request component 650 is capable of, configured to, or operable to support a means for transmitting a request for the UE to indicate information associated with the downlink STO of the UE, where reception of the indication is based on the request.

In some examples, the request and the first downlink signal are transmitted as part of a same downlink transmission.

In some examples, the request is transmitted according to a periodic or aperiodic rate of transmission.

In some examples, the request is transmitted via a physical layer at the UE.

In some examples, the feedback component 635 is capable of, configured to, or operable to support a means for receiving a recommendation to update the downlink STO based on the second downlink signal.

In some examples, the recommendation is based on whether the second downlink signal is associated with an aggregated phase difference across samples received in a frequency domain.

In some examples, the recommendation is received via an uplink control channel.

In some examples, the equalization component 630 is capable of, configured to, or operable to support a means for transmitting a third downlink signal that is equalized, by the network entity, in accordance with the second estimated channel, where the second estimated channel is based on the first estimated channel and the uplink STO associated with the UE. In some examples, the feedback component 635 is capable of, configured to, or operable to support a means for receiving a second indication of an updated downlink STO associated with the UE based on transmission of the third downlink signal. In some examples, the equalization component 630 is capable of, configured to, or operable to support a means for equalizing a fourth downlink signal in accordance with a fourth estimated channel, where the fourth estimated channel is based on both the updated downlink STO associated with the UE and the uplink STO associated with the UE. In some examples, the equalization component 630 is capable of, configured to, or operable to support a means for transmitting the fourth downlink signal based on equalization of the fourth downlink signal.

In some examples, transmission of the third downlink signal is based on reception of a recommendation to update the downlink STO or transmission of a request for the UE to update the downlink STO.

In some examples, the third downlink signal is a repetition of the first downlink signal.

In some examples, the estimation component 625 is capable of, configured to, or operable to support a means for estimating the uplink STO associated with the UE based on the uplink signal received from the UE.

In some examples, the first downlink signal is further based on the downlink STO associated with the UE.

In some examples, the indication of the downlink STO is received via an uplink control channel.

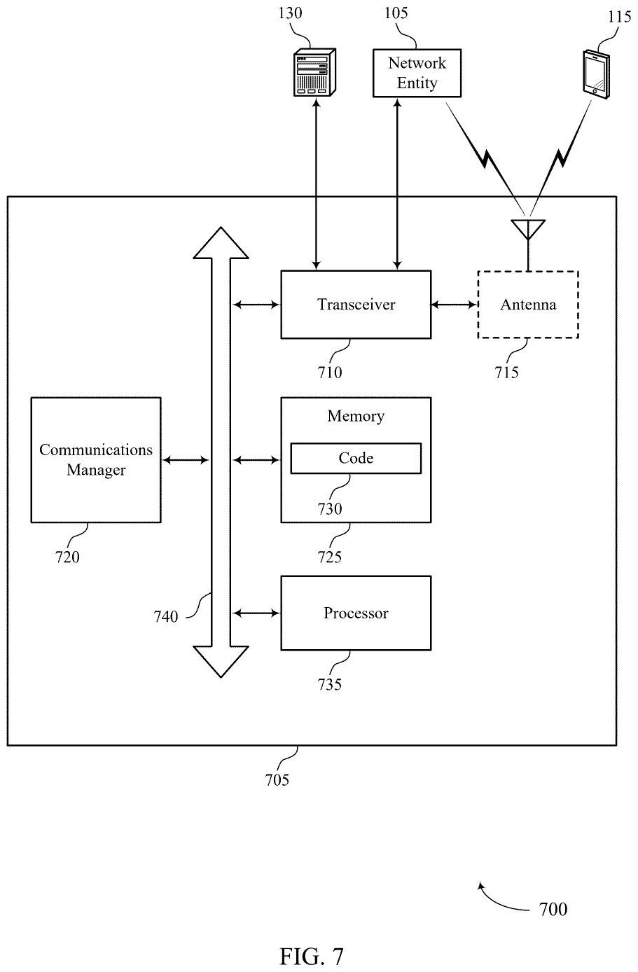

FIG. 7 shows a diagram of a system 700 including a device 705 that supports techniques for Tx equalization based on STOs associated with a UE in accordance with one or more aspects of the present disclosure. The device 705 may be an example of or include components of a device 405, a device 505, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a communications manager 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired Tx), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting techniques for Tx equalization based on STOs associated with a UE). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network entities 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

The communications manager 720 may support wireless communications in accordance with examples as disclosed herein. For example, the communications manager 720 is capable of, configured to, or operable to support a means for estimating an uplink STO associated with a UE based on uplink signal associated with the UE, where the uplink STO is removed from a first estimated channel to generate a second estimated channel. The communications manager 720 is capable of, configured to, or operable to support a means for equalizing a first downlink signal in accordance with the second estimated channel based on removal of the uplink STO from the first estimated channel. The communications manager 720 is capable of, configured to, or operable to support a means for transmitting the first downlink signal based on equalization of the first downlink signal. The communications manager 720 is capable of, configured to, or operable to support a means for receiving an indication of a downlink STO associated with the UE based on transmission of the first downlink signal. The communications manager 720 is capable of, configured to, or operable to support a means for equalizing a second downlink signal in accordance with a third estimated channel, where the third estimated channel is based on both the downlink STO associated with the UE and the uplink STO associated with the UE. The communications manager 720 is capable of, configured to, or operable to support a means for transmitting, to the UE, the second downlink signal based on equalization of the second downlink signal.

By including or configuring the communications manager 720 in accordance with examples as described herein, the device 705 may support techniques for Tx equalization based on UE STOs, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of techniques for Tx equalization based on STOs associated with a UE as described herein, or the at least one processor 735 and the at least one memory 725 may be otherwise configured to, individually or collectively, perform or support such operations.

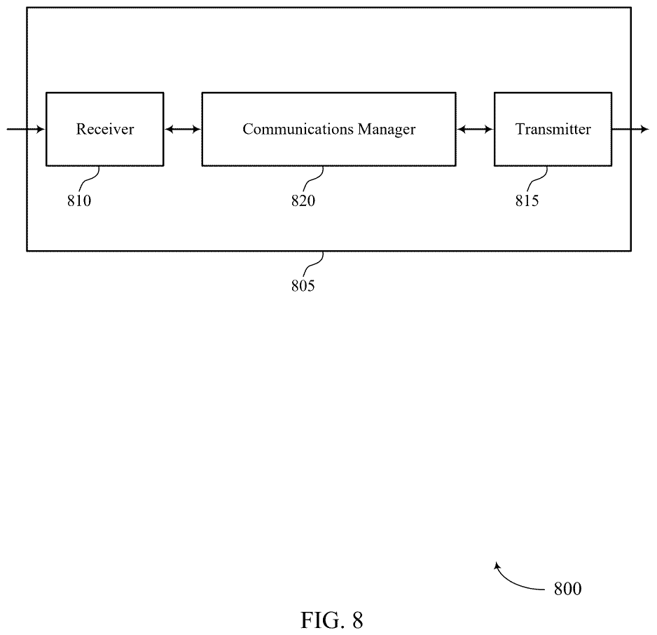

FIG. 8 shows a block diagram 800 of a device 805 that supports techniques for Tx equalization based on STOs associated with a UE in accordance with one or more aspects of the present disclosure. The device 805 may be an example of aspects of a UE 115 as described herein. The device 805 may include a receiver 810, a Tx 815, and a communications manager 820. The device 805, or one or more components of the device 805 (e.g., the receiver 810, the Tx 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for Tx equalization based on STOs associated with a UE). Information may be passed on to other components of the device 805. The receiver 810 may utilize a single antenna or a set of multiple antennas.

The Tx 815 may provide a means for transmitting signals generated by other components of the device 805. For example, the Tx 815 may transmit information such as packets, user data, control information, or any combination thereof associated with various information channels (e.g., control channels, data channels, information channels related to techniques for Tx equalization based on STOs associated with a UE). In some examples, the Tx 815 may be co-located with a receiver 810 in a transceiver module. The Tx 815 may utilize a single antenna or a set of multiple antennas.

The communications manager 820, the receiver 810, the Tx 815, or various combinations or components thereof may be examples of means for performing various aspects of techniques for Tx equalization based on STOs associated with a UE as described herein. For example, the communications manager 820, the receiver 810, the Tx 815, or various combinations or components thereof may be capable of performing one or more of the functions described herein.

In some examples, the communications manager 820, the receiver 810, the Tx 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the Tx 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the Tx 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the Tx 815, or both. For example, the communications manager 820 may receive information from the receiver 810, send information to the Tx 815, or be integrated in combination with the receiver 810, the Tx 815, or both to obtain information, output information, or perform various other operations as described herein.

The communications manager 820 may support wireless communications in accordance with examples as disclosed herein. For example, the communications manager 820 is capable of, configured to, or operable to support a means for receiving, from a network entity, a first downlink signal that is equalized in accordance with a second estimated channel, where the second estimated channel is based on a first estimated channel and an uplink STO associated with the UE. The communications manager 820 is capable of, configured to, or operable to support a means for transmitting an indication of a downlink STO associated with the UE, where the downlink STO is based on the first downlink signal. The communications manager 820 is capable of, configured to, or operable to support a means for receiving, based on transmitting the indication of the downlink STO, a second downlink signal that is equalized in accordance with a third estimated channel, where the third estimated channel is based on both the downlink STO associated with the UE and the uplink STO associated with the UE.

By including or configuring the communications manager 820 in accordance with examples as described herein, the device 805 (e.g., at least one processor controlling or otherwise coupled with the receiver 810, the Tx 815, the communications manager 820, or a combination thereof) may support techniques for Tx equalization based on UE STOs, which may result in reduced processing, reduced power consumption, more efficient utilization of communication resources, among other advantages.

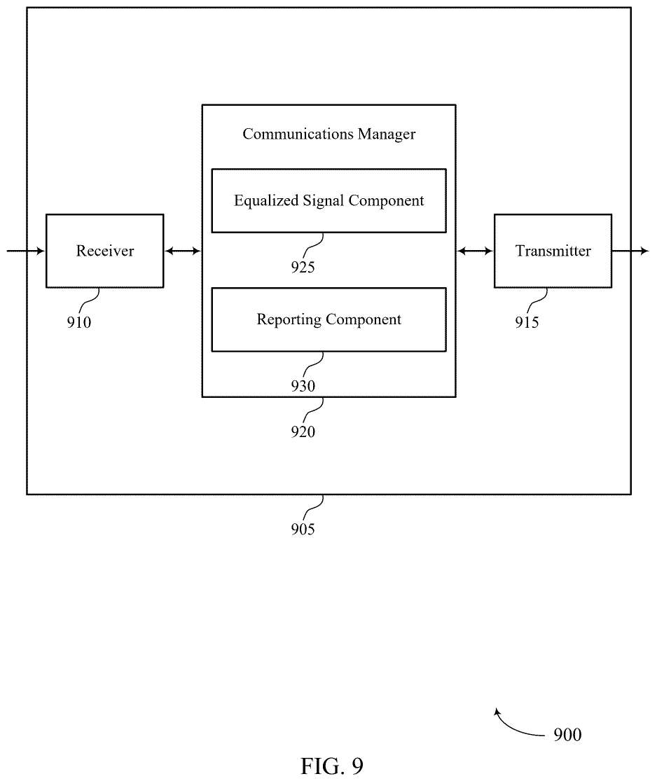

FIG. 9 shows a block diagram 900 of a device 905 that supports techniques for Tx equalization based on STOs associated with a UE in accordance with one or more aspects of the present disclosure. The device 905 may be an example of aspects of a device 805 or a UE 115 as described herein. The device 905 may include a receiver 910, a Tx 915, and a communications manager 920. The device 905, or one or more components of the device 905 (e.g., the receiver 910, the Tx 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for Tx equalization based on STOs associated with a UE). Information may be passed on to other components of the device 905. The receiver 910 may utilize a single antenna or a set of multiple antennas.

The Tx 915 may provide a means for transmitting signals generated by other components of the device 905. For example, the Tx 915 may transmit information such as packets, user data, control information, or any combination thereof associated with various information channels (e.g., control channels, data channels, information channels related to techniques for Tx equalization based on STOs associated with a UE). In some examples, the Tx 915 may be co-located with a receiver 910 in a transceiver module. The Tx 915 may utilize a single antenna or a set of multiple antennas.

The device 905, or various components thereof, may be an example of means for performing various aspects of techniques for Tx equalization based on STOs associated with a UE as described herein. For example, the communications manager 920 may include an equalized signal component 925 a reporting component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the Tx 915, or both. For example, the communications manager 920 may receive information from the receiver 910, send information to the Tx 915, or be integrated in combination with the receiver 910, the Tx 915, or both to obtain information, output information, or perform various other operations as described herein.

The communications manager 920 may support wireless communications in accordance with examples as disclosed herein. The equalized signal component 925 is capable of, configured to, or operable to support a means for receiving, from a network entity, a first downlink signal that is equalized in accordance with a second estimated channel, where the second estimated channel is based on a first estimated channel and an uplink STO associated with the UE. The reporting component 930 is capable of, configured to, or operable to support a means for transmitting an indication of a downlink STO associated with the UE, where the downlink STO is based on the first downlink signal. The equalized signal component 925 is capable of, configured to, or operable to support a means for receiving, based on transmitting the indication of the downlink STO, a second downlink signal that is equalized in accordance with a third estimated channel, where the third estimated channel is based on both the downlink STO associated with the UE and the uplink STO associated with the UE.

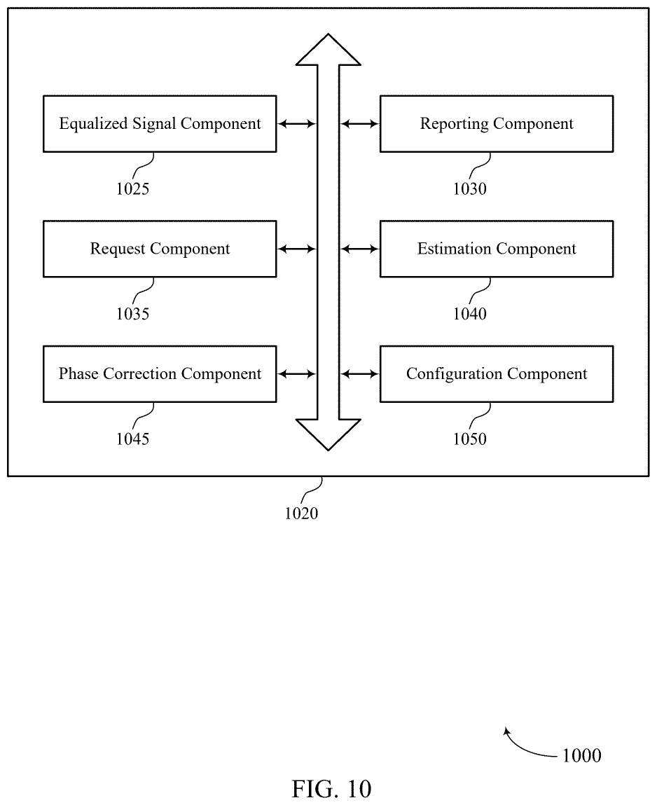

FIG. 10 shows a block diagram 1000 of a communications manager 1020 that supports techniques for Tx equalization based on STOs associated with a UE in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for Tx equalization based on STOs associated with a UE as described herein. For example, the communications manager 1020 may include an equalized signal component 1025, a reporting component 1030, a request component 1035, an estimation component 1040, a phase correction component 1045, a configuration component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The equalized signal component 1025 is capable of, configured to, or operable to support a means for receiving, from a network entity, a first downlink signal that is equalized in accordance with a second estimated channel, where the second estimated channel is based on a first estimated channel and an uplink STO associated with the UE. The reporting component 1030 is capable of, configured to, or operable to support a means for transmitting an indication of a downlink STO associated with the UE, where the downlink STO is based on the first downlink signal. In some examples, the equalized signal component 1025 is capable of, configured to, or operable to support a means for receiving, based on transmitting the indication of the downlink STO, a second downlink signal that is equalized in accordance with a third estimated channel, where the third estimated channel is based on both the downlink STO associated with the UE and the uplink STO associated with the UE.

In some examples, the second estimated channel is based on a first phase correcting factor. In some examples, the first phase correcting factor is based on the uplink STO.

In some examples, the third estimated channel is an estimate of an actual downlink channel used to receive the second downlink signal. In some examples, the third estimated channel is based on a second phase correcting factor. In some examples, the second phase correcting factor is based on the downlink STO.

In some examples, the request component 1035 is capable of, configured to, or operable to support a means for receiving a request for the UE to indicate the downlink STO of the UE, where transmitting the indication of the downlink STO is based on the request.

In some examples, the request and the first downlink signal are received as part of a same downlink transmission.

In some examples, the request is received according to a periodic or aperiodic rate of reception.

In some examples, the request is received via a physical layer at the UE.

In some examples, the reporting component 1030 is capable of, configured to, or operable to support a means for transmitting a recommendation to update the downlink STO based on the second downlink signal.

In some examples, the recommendation is based on whether the second downlink signal is associated with an aggregated phase difference across samples received in a frequency domain.

In some examples, the recommendation is transmitted via an uplink control channel.

In some examples, the equalized signal component 1025 is capable of, configured to, or operable to support a means for receiving, from the network entity, a third downlink signal that is equalized in accordance with the second estimated channel, where the second estimated channel is based on the first estimated channel and the uplink STO associated with the UE. In some examples, the reporting component 1030 is capable of, configured to, or operable to support a means for transmitting a second indication of an updated downlink STO associated with the UE, where the updated downlink STO is based on the third downlink signal. In some examples, the equalized signal component 1025 is capable of, configured to, or operable to support a means for receiving, based on transmitting the second indication of the downlink STO, a fourth downlink signal that is equalized in accordance with a fourth estimated channel, where the fourth estimated channel is based on both the updated downlink STO associated with the UE and the uplink STO associated with the UE.

In some examples, receiving the third downlink signal is based on transmission of a recommendation to update the downlink STO or reception of a request for the UE to update the downlink STO.

In some examples, the third downlink signal is a repetition of the first downlink signal.

In some examples, the estimation component 1040 is capable of, configured to, or operable to support a means for estimating the downlink STO based on the first downlink signal, where transmission of the indication is based on the estimation.

In some examples, estimating the downlink STO is based on reception of a request from the network entity.

In some examples, the equalized signal component 1025 is capable of, configured to, or operable to support a means for refraining from equalizing the second downlink signal based on the second downlink signal being equalized in accordance with the third estimated channel.

In some examples, the phase correction component 1045 is capable of, configured to, or operable to support a means for multiplying the second downlink signal by an inverse of a phase correcting factor based on the second downlink signal being equalized in accordance with the third estimated channel.

In some examples, the configuration component 1050 is capable of, configured to, or operable to support a means for receiving a control message indicative of the phase correcting factor.

In some examples, the estimation component 1040 is capable of, configured to, or operable to support a means for estimating the phase correcting factor.

In some examples, the first downlink signal is further based on the downlink STO associated with the UE.

In some examples, the indication of the downlink STO is transmitted via an uplink control channel.

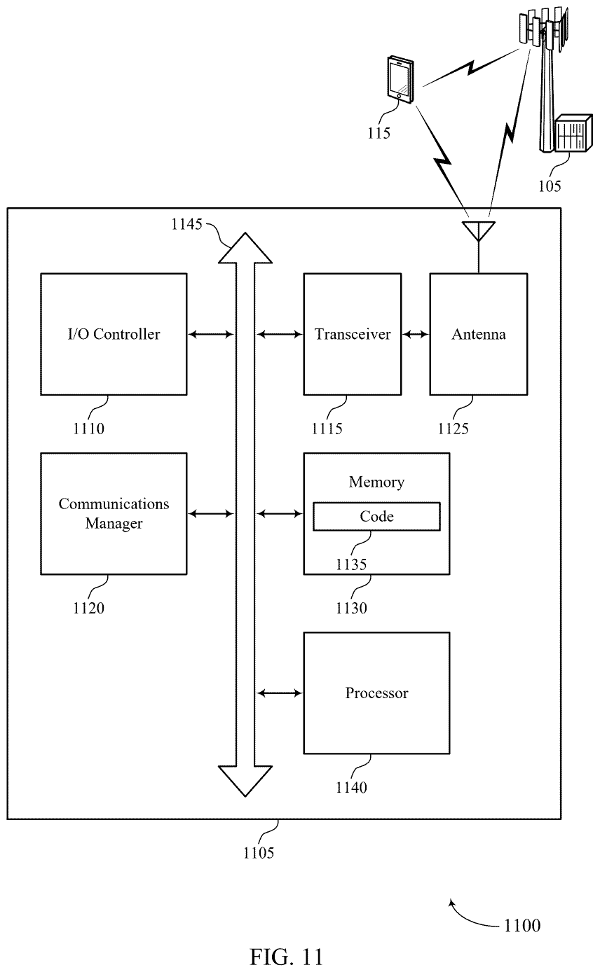

FIG. 11 shows a diagram of a system 1100 including a device 1105 that supports techniques for Tx equalization based on STOs associated with a UE in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a Tx 815, a Tx 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting techniques for Tx equalization based on STOs associated with a UE). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving, from a network entity, a first downlink signal that is equalized in accordance with a second estimated channel, where the second estimated channel is based on a first estimated channel and an uplink STO associated with the UE. The communications manager 1120 is capable of, configured to, or operable to support a means for transmitting an indication of a downlink STO associated with the UE, where the downlink STO is based on the first downlink signal. The communications manager 1120 is capable of, configured to, or operable to support a means for receiving, based on transmitting the indication of the downlink STO, a second downlink signal that is equalized in accordance with a third estimated channel, where the third estimated channel is based on both the downlink STO associated with the UE and the uplink STO associated with the UE.

By including or configuring the communications manager 1120 in accordance with examples as described herein, the device 1105 may support techniques for Tx equalization based on UE STOs, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of techniques for Tx equalization based on STOs associated with a UE as described herein, or the at least one processor 1140 and the at least one memory 1130 may be otherwise configured to, individually or collectively, perform or support such operations.

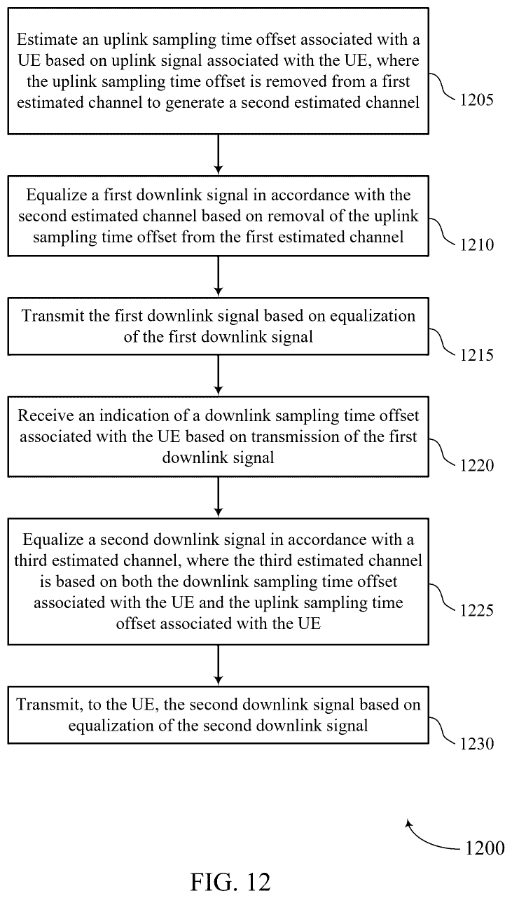

FIG. 12 shows a flowchart illustrating a method 1200 that supports techniques for Tx equalization based on STOs associated with a UE in accordance with one or more aspects of the present disclosure. The operations of the method 1200 may be implemented by a network entity or its components as described herein. For example, the operations of the method 1200 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1205, the method may include estimating an uplink STO associated with a UE based on uplink signal associated with the UE, where the uplink STO is removed from a first estimated channel to generate a second estimated channel. The operations of 1205 may be performed in accordance with examples as disclosed herein. In some examples, aspects of the operations of 1205 may be performed by an estimation component 625 as described with reference to FIG. 6.

At 1210, the method may include equalizing a first downlink signal in accordance with the second estimated channel based on removal of the uplink STO from the first estimated channel. The operations of 1210 may be performed in accordance with examples as disclosed herein. In some examples, aspects of the operations of 1210 may be performed by an equalization component 630 as described with reference to FIG. 6.

At 1215, the method may include transmitting the first downlink signal based on equalization of the first downlink signal. The operations of 1215 may be performed in accordance with examples as disclosed herein. In some examples, aspects of the operations of 1215 may be performed by an equalization component 630 as described with reference to FIG. 6.

At 1220, the method may include receiving an indication of a downlink STO associated with the UE based on transmission of the first downlink signal. The operations of 1220 may be performed in accordance with examples as disclosed herein. In some examples, aspects of the operations of 1220 may be performed by a feedback component 635 as described with reference to FIG. 6.

At 1225, the method may include equalizing a second downlink signal in accordance with a third estimated channel, where the third estimated channel is based on both the downlink STO associated with the UE and the uplink STO associated with the UE. The operations of 1225 may be performed in accordance with examples as disclosed herein. In some examples, aspects of the operations of 1225 may be performed by an equalization component 630 as described with reference to FIG. 6.

At 1230, the method may include transmitting, to the UE, the second downlink signal based on equalization of the second downlink signal. The operations of 1230 may be performed in accordance with examples as disclosed herein. In some examples, aspects of the operations of 1230 may be performed by an equalization component 630 as described with reference to FIG. 6.

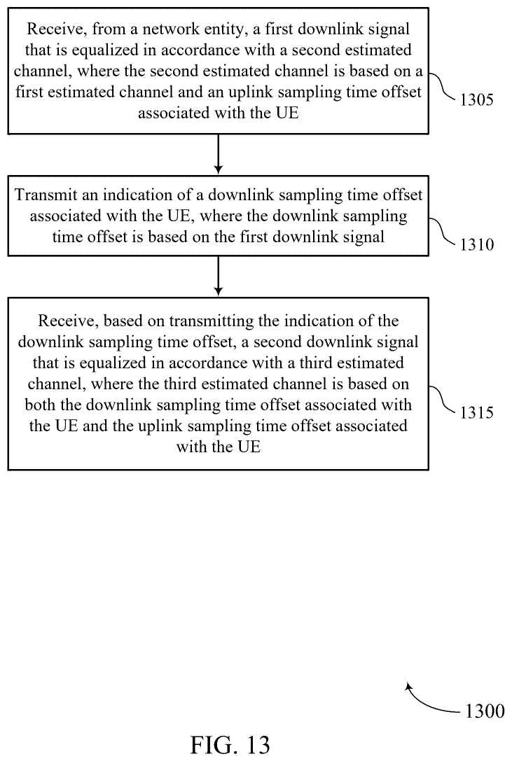

FIG. 13 shows a flowchart illustrating a method 1300 that supports techniques for Tx equalization based on STOs associated with a UE in accordance with one or more aspects of the present disclosure. The operations of the method 1300 may be implemented by a UE or its components as described herein. For example, the operations of the method 1300 may be performed by a UE 115 as described with reference to FIGS. 1 through 3 and 8 through 11. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, a first downlink signal that is equalized in accordance with a second estimated channel, where the second estimated channel is based on a first estimated channel and an uplink STO associated with the UE. The operations of 1305 may be performed in accordance with examples as disclosed herein. In some examples, aspects of the operations of 1305 may be performed by an equalized signal component 1025 as described with reference to FIG. 10.

At 1310, the method may include transmitting an indication of a downlink STO associated with the UE, where the downlink STO is based on the first downlink signal. The operations of 1310 may be performed in accordance with examples as disclosed herein. In some examples, aspects of the operations of 1310 may be performed by a reporting component 1030 as described with reference to FIG. 10.

At 1315, the method may include receiving, based on transmitting the indication of the downlink STO, a second downlink signal that is equalized in accordance with a third estimated channel, where the third estimated channel is based on both the downlink STO associated with the UE and the uplink STO associated with the UE. The operations of 1315 may be performed in accordance with examples as disclosed herein. In some examples, aspects of the operations of 1315 may be performed by an equalized signal component 1025 as described with reference to FIG. 10.

The following provides an overview of aspects of the present disclosure:

Aspect 1: A method for wireless communications at a network entity, comprising: estimating an uplink STO associated with a UE based at least in part on uplink signal associated with the UE, wherein the uplink STO is removed from a first estimated channel to generate a second estimated channel; equalizing a first downlink signal in accordance with the second estimated channel based at least in part on removal of the uplink STO from the first estimated channel; transmitting the first downlink signal based at least in part on equalization of the first downlink signal; receiving an indication of a downlink STO associated with the UE based at least in part on transmission of the first downlink signal; equalizing a second downlink signal in accordance with a third estimated channel, wherein the third estimated channel is based at least in part on both the downlink STO associated with the UE and the uplink STO associated with the UE; and transmitting, to the UE, the second downlink signal based at least in part on equalization of the second downlink signal.

Aspect 2: The method of aspect 1, wherein removal of the uplink STO from the first estimated channel comprises: generating a first phase correcting factor based at least in part on the uplink STO estimated by the network entity; and extracting, from the first estimated channel, the second estimated channel based at least in part on the first phase correcting factor.

Aspect 3: The method of any of aspects 1 through 2, wherein equalizing the second downlink signal comprises: generating a second phase correcting factor associated with the downlink STO; applying the second phase correcting factor to the second estimated channel to generate the third estimated channel, wherein the third estimated channel is an estimate of an actual downlink channel to be used for transmission of the second downlink signal; and equalizing the second downlink signal in accordance with the third estimated channel.

Aspect 4: The method of any of aspects 1 through 3, further comprising: transmitting a request for the UE to indicate information associated with the downlink STO of the UE, wherein reception of the indication is based at least in part on the request.

Aspect 5: The method of aspect 4, wherein the request and the first downlink signal are transmitted as part of a same downlink transmission.

Aspect 6: The method of any of aspects 4 through 5, wherein the request is transmitted according to a periodic or aperiodic rate of transmission.

Aspect 7: The method of any of aspects 4 through 6, wherein the request is transmitted via a physical layer at the UE.

Aspect 8: The method of any of aspects 1 through 7, further comprising: receiving a recommendation to update the downlink STO based at least in part on the second downlink signal.

Aspect 9: The method of aspect 8, wherein the recommendation is based at least in part on whether the second downlink signal is associated with an aggregated phase difference across samples received in a frequency domain.

Aspect 10: The method of any of aspects 8 through 9, wherein the recommendation is received via an uplink control channel.

Aspect 11: The method of any of aspects 1 through 10, further comprising: transmitting a third downlink signal that is equalized, by the network entity, in accordance with the second estimated channel, wherein the second estimated channel is based at least in part on the first estimated channel and the uplink STO associated with the UE; receiving a second indication of an updated downlink STO associated with the UE based at least in part on transmission of the third downlink signal; equalizing a fourth downlink signal in accordance with a fourth estimated channel, wherein the fourth estimated channel is based at least in part on both the updated downlink STO associated with the UE and the uplink STO associated with the UE; and transmitting the fourth downlink signal based at least in part on equalization of the fourth downlink signal.

Aspect 12: The method of aspect 11, wherein transmission of the third downlink signal is based at least in part on reception of a recommendation to update the downlink STO or transmission of a request for the UE to update the downlink STO.

Aspect 13: The method of any of aspects 11 through 12, wherein the third downlink signal is a repetition of the first downlink signal.

Aspect 14: The method of any of aspects 1 through 13, further comprising: estimating the uplink STO associated with the UE based at least in part on the uplink signal received from the UE.

Aspect 15: The method of any of aspects 1 through 14, wherein the first downlink signal is further based at least in part on the downlink STO associated with the UE.

Aspect 16: The method of any of aspects 1 through 15, wherein the indication of the downlink STO is received via an uplink control channel.

Aspect 17: A method for wireless communications at a UE, comprising: receiving, from a network entity, a first downlink signal that is equalized in accordance with a second estimated channel, wherein the second estimated channel is based at least in part on a first estimated channel and an uplink STO associated with the UE; transmitting an indication of a downlink STO associated with the UE, wherein the downlink STO is based at least in part on the first downlink signal; and receiving, based at least in part on transmitting the indication of the downlink STO, a second downlink signal that is equalized in accordance with a third estimated channel, wherein the third estimated channel is based at least in part on both the downlink STO associated with the UE and the uplink STO associated with the UE.

Aspect 18: The method of aspect 17, wherein the second estimated channel is based at least in part on a first phase correcting factor, and the first phase correcting factor is based at least in part on the uplink STO.

Aspect 19: The method of any of aspects 17 through 18, wherein the third estimated channel is an estimate of an actual downlink channel used to receive the second downlink signal, the third estimated channel is based at least in part on a second phase correcting factor, and the second phase correcting factor is based at least in part on the downlink STO.

Aspect 20: The method of any of aspects 17 through 19, further comprising: receiving a request for the UE to indicate the downlink STO of the UE, wherein transmitting the indication of the downlink STO is based at least in part on the request.

Aspect 21: The method of aspect 20, wherein the request and the first downlink signal are received as part of a same downlink transmission.

Aspect 22: The method of any of aspects 20 through 21, wherein the request is received according to a periodic or aperiodic rate of reception.

Aspect 23: The method of any of aspects 20 through 22, wherein the request is received via a physical layer at the UE.

Aspect 24: The method of any of aspects 17 through 23, further comprising: transmitting a recommendation to update the downlink STO based at least in part on the second downlink signal.

Aspect 25: The method of aspect 24, wherein the recommendation is based at least in part on whether the second downlink signal is associated with an aggregated phase difference across samples received in a frequency domain.

Aspect 26: The method of any of aspects 24 through 25, wherein the recommendation is transmitted via an uplink control channel.

Aspect 27: The method of any of aspects 17 through 26, further comprising: receiving, from the network entity, a third downlink signal that is equalized in accordance with the second estimated channel, wherein the second estimated channel is based at least in part on the first estimated channel and the uplink STO associated with the UE; transmitting a second indication of an updated downlink STO associated with the UE, wherein the updated downlink STO is based at least in part on the third downlink signal; and receiving, based at least in part on transmitting the second indication of the downlink STO, a fourth downlink signal that is equalized in accordance with a fourth estimated channel, wherein the fourth estimated channel is based at least in part on both the updated downlink STO associated with the UE and the uplink STO associated with the UE.

Aspect 28: The method of aspect 27, wherein receiving the third downlink signal is based at least in part on transmission of a recommendation to update the downlink STO or reception of a request for the UE to update the downlink STO.

Aspect 29: The method of any of aspects 27 through 28, wherein the third downlink signal is a repetition of the first downlink signal.

Aspect 30: The method of any of aspects 17 through 29, further comprising: estimating the downlink STO based at least in part on the first downlink signal, wherein transmission of the indication is based at least in part on the estimation.

Aspect 31: The method of aspect 30, wherein estimating the downlink STO is based at least in part on reception of a request from the network entity.

Aspect 32: The method of any of aspects 17 through 31, further comprising: refraining from equalizing the second downlink signal based at least in part on the second downlink signal being equalized in accordance with the third estimated channel.

Aspect 33: The method of any of aspects 17 through 32, further comprising: multiplying the second downlink signal by an inverse of a phase correcting factor based at least in part on the second downlink signal being equalized in accordance with the third estimated channel.

Aspect 34: The method of aspect 33, further comprising: receiving a control message indicative of the phase correcting factor.

Aspect 35: The method of any of aspects 33 through 34, further comprising: estimating the phase correcting factor.

Aspect 36: The method of any of aspects 17 through 35, wherein the first downlink signal is further based at least in part on the downlink STO associated with the UE.

Aspect 37: The method of any of aspects 17 through 36, wherein the indication of the downlink STO is transmitted via an uplink control channel.

Aspect 38: A network entity for wireless communications, comprising one or more memories storing processor-executable code, and one or more processors coupled with the one or more memories and individually or collectively operable to execute the code to cause the network entity to perform a method of any of aspects 1 through 16.

Aspect 39: A network entity for wireless communications, comprising at least one means for performing a method of any of aspects 1 through 16.

Aspect 40: A non-transitory computer-readable medium storing code for wireless communications, the code comprising instructions executable by one or more processors to perform a method of any of aspects 1 through 16.

Aspect 41: A UE for wireless communications, comprising one or more memories storing processor-executable code, and one or more processors coupled with the one or more memories and individually or collectively operable to execute the code to cause the UE to perform a method of any of aspects 17 through 37.

Aspect 42: A UE for wireless communications, comprising at least one means for performing a method of any of aspects 17 through 37.

Aspect 43: A non-transitory computer-readable medium storing code for wireless communications, the code comprising instructions executable by one or more processors to perform a method of any of aspects 17 through 37.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
estimate an uplink sampling time offset associated with a user equipment (UE) based at least in part on uplink signal associated with the UE, wherein the uplink sampling time offset is removed from a first estimated channel to generate a second estimated channel;
equalize a first downlink signal in accordance with the second estimated channel based at least in part on removal of the uplink sampling time offset from the first estimated channel;
transmit the first downlink signal based at least in part on equalization of the first downlink signal;
receive an indication of a downlink sampling time offset associated with the UE based at least in part on transmission of the first downlink signal;
equalize a second downlink signal in accordance with a third estimated channel, wherein the third estimated channel is based at least in part on both the downlink sampling time offset associated with the UE and the uplink sampling time offset associated with the UE; and
transmit, to the UE, the second downlink signal based at least in part on equalization of the second downlink signal.

2. The network entity of claim 1, wherein, to removal of the uplink sample time offset from the first estimated channel, the one or more processors are individually or collectively operable to execute the code to cause the network entity to:
generate a first phase correcting factor based at least in part on the uplink sampling time offset estimated by the network entity; and
extract, from the first estimated channel, the second estimated channel based at least in part on the first phase correcting factor.

3. The network entity of claim 1, wherein, to equalize the second downlink signal, the one or more processors are individually or collectively operable to execute the code to cause the network entity to:
generate a second phase correcting factor associated with the downlink sampling time offset;
apply the second phase correcting factor to the second estimated channel to generate the third estimated channel, wherein the third estimated channel is an estimate of an actual downlink channel to be used for transmission of the second downlink signal; and
equalize the second downlink signal in accordance with the third estimated channel.

4. The network entity of claim 1, wherein the one or more processors are individually or collectively further operable to execute the code to cause the network entity to:
transmit a request for the UE to indicate information associated with the downlink sampling time offset of the UE, wherein reception of the indication is based at least in part on the request.

5. The network entity of claim 4, wherein the request and the first downlink signal are transmitted as part of a same downlink transmission.

6. The network entity of claim 4, wherein the request is transmitted according to a periodic or aperiodic rate of transmission.

7. The network entity of claim 1, wherein the one or more processors are individually or collectively further operable to execute the code to cause the network entity to:
receive a recommendation to update the downlink sampling time offset based at least in part on the second downlink signal.

8. The network entity of claim 7, wherein the recommendation is based at least in part on whether the second downlink signal is associated with an aggregated phase difference across samples received in a frequency domain.

9. The network entity of claim 1, wherein the one or more processors are individually or collectively further operable to execute the code to cause the network entity to:
transmit a third downlink signal that is equalized, by the network entity, in accordance with the second estimated channel, wherein the second estimated channel is based at least in part on the first estimated channel and the uplink sampling time offset associated with the UE;
receive a second indication of an updated downlink sampling time offset associated with the UE based at least in part on transmission of the third downlink signal;
equalize a fourth downlink signal in accordance with a fourth estimated channel, wherein the fourth estimated channel is based at least in part on both the updated downlink sampling time offset associated with the UE and the uplink sampling time offset associated with the UE; and
transmit the fourth downlink signal based at least in part on equalization of the fourth downlink signal.

10. The network entity of claim 9, wherein transmission of the third downlink signal is based at least in part on reception of a recommendation to update the downlink sampling time offset or transmission of a request for the UE to update the downlink sampling time offset.

11. The network entity of claim 1, wherein the first downlink signal is further based at least in part on the downlink sampling time offset associated with the UE.

12. A user equipment (UE), comprising:
one or more memories storing processor-executable code; and
one or more processors coupled with the one or more memories and individually or collectively operable to execute the code to cause the UE to:
receive, from a network entity, a first downlink signal that is equalized in accordance with a second estimated channel, wherein the second estimated channel is based at least in part on a first estimated channel and an uplink sampling time offset associated with the UE;
transmit an indication of a downlink sampling time offset associated with the UE, wherein the downlink sampling time offset is based at least in part on the first downlink signal; and
receive, based at least in part on transmitting the indication of the downlink sampling time offset, a second downlink signal that is equalized in accordance with a third estimated channel, wherein the third estimated channel is based at least in part on both the downlink sampling time offset associated with the UE and the uplink sampling time offset associated with the UE.

13. The UE of claim 12, wherein the second estimated channel is based at least in part on a first phase correcting factor, and wherein the first phase correcting factor is based at least in part on the uplink sampling time offset.

14. The UE of claim 12, wherein the third estimated channel is an estimate of an actual downlink channel used to receive the second downlink signal, wherein the third estimated channel is based at least in part on a second phase correcting factor, and wherein the second phase correcting factor is based at least in part on the downlink sampling time offset.

15. The UE of claim 12, wherein the one or more processors are individually or collectively further operable to execute the code to cause the UE to:
receive a request for the UE to indicate the downlink sampling time offset of the UE, wherein transmitting the indication of the downlink sampling time offset is based at least in part on the request.

16. The UE of claim 15, wherein the request and the first downlink signal are received as part of a same downlink transmission.

17. The UE of claim 15, wherein the request is received according to a periodic or aperiodic rate of reception.

18. The UE of claim 12, wherein the one or more processors are individually or collectively further operable to execute the code to cause the UE to:
transmit a recommendation to update the downlink sampling time offset based at least in part on the second downlink signal.

19. The UE of claim 18, wherein the recommendation is based at least in part on whether the second downlink signal is associated with an aggregated phase difference across samples received in a frequency domain.

20. The UE of claim 12, wherein the one or more processors are individually or collectively further operable to execute the code to cause the UE to:
receive, from the network entity, a third downlink signal that is equalized in accordance with the second estimated channel, wherein the second estimated channel is based at least in part on the first estimated channel and the uplink sampling time offset associated with the UE;
transmit a second indication of an updated downlink sampling time offset associated with the UE, wherein the updated downlink sampling time offset is based at least in part on the third downlink signal; and
receive, based at least in part on transmitting the second indication of the downlink sampling time offset, a fourth downlink signal that is equalized in accordance with a fourth estimated channel, wherein the fourth estimated channel is based at least in part on both the updated downlink sampling time offset associated with the UE and the uplink sampling time offset associated with the UE.

21. The UE of claim 20, wherein receiving the third downlink signal is based at least in part on transmission of a recommendation to update the downlink sampling time offset or reception of a request for the UE to update the downlink sampling time offset.

22. The UE of claim 12, wherein the one or more processors are individually or collectively further operable to execute the code to cause the UE to:
estimate the downlink sampling time offset based at least in part on the first downlink signal, wherein transmission of the indication is based at least in part on the estimation.

23. The UE of claim 22, wherein estimating the downlink sampling time offset is based at least in part on reception of a request from the network entity.

24. The UE of claim 12, wherein the one or more processors are individually or collectively further operable to execute the code to cause the UE to:
refrain from equalizing the second downlink signal based at least in part on the second downlink signal being equalized in accordance with the third estimated channel.

25. The UE of claim 12, wherein the one or more processors are individually or collectively further operable to execute the code to cause the UE to:
multiply the second downlink signal by an inverse of a phase correcting factor based at least in part on the second downlink signal being equalized in accordance with the third estimated channel.

26. The UE of claim 25, wherein the one or more processors are individually or collectively further operable to execute the code to cause the UE to:
receive a control message indicative of the phase correcting factor.

27. The UE of claim 25, wherein the one or more processors are individually or collectively further operable to execute the code to cause the UE to:
estimate the phase correcting factor.

28. The UE of claim 12, wherein the first downlink signal is further based at least in part on the downlink sampling time offset associated with the UE.

29. A method for wireless communications at a network entity, comprising:
estimating an uplink sampling time offset associated with a user equipment (UE) based at least in part on uplink signal associated with the UE, wherein the uplink sampling time offset is removed from a first estimated channel to generate a second estimated channel;
equalizing a first downlink signal in accordance with the second estimated channel based at least in part on removal of the uplink sampling time offset from the first estimated channel;
transmitting the first downlink signal based at least in part on equalization of the first downlink signal;
receiving an indication of a downlink sampling time offset associated with the UE based at least in part on transmission of the first downlink signal;
equalizing a second downlink signal in accordance with a third estimated channel, wherein the third estimated channel is based at least in part on both the downlink sampling time offset associated with the UE and the uplink sampling time offset associated with the UE; and
transmitting, to the UE, the second downlink signal based at least in part on equalization of the second downlink signal.

30. A method for wireless communications at a user equipment (UE), comprising:
receiving, from a network entity, a first downlink signal that is equalized in accordance with a second estimated channel, wherein the second estimated channel is based at least in part on a first estimated channel and an uplink sampling time offset associated with the UE;
transmitting an indication of a downlink sampling time offset associated with the UE, wherein the downlink sampling time offset is based at least in part on the first downlink signal; and
receiving, based at least in part on transmitting the indication of the downlink sampling time offset, a second downlink signal that is equalized in accordance with a third estimated channel, wherein the third estimated channel is based at least in part on both the downlink sampling time offset associated with the UE and the uplink sampling time offset associated with the UE.
